(19) United States
(12) Patent Application Publication
(10) Pub. No.: US 2003/0138373 A1
(43) Pub. Date: Jul. 24, 2003

(54) Process for making hydrogen gas

(76) Inventors: David E. Graham, Long Valley, NJ (US); Richard Yodice, Mentor, OH (US); James D. Burrington, Mayfield Village, OH (US); Deborah A. Langer, Chesterland, OH (US); John J. Mullay, Mentor, OH (US)

Correspondence Address: The Lubrizol Corporation, 29400 Lakeland Boulevard, Wickliffe, OH, 44092-2298, US

(21) Appl. No.: 10/008,130

(22) Filed: Nov. 5, 2001

(51) Int. Cl. C01B 3/24

(52) U.S. Cl. 423/650; 423/652

(57) ABSTRACT

This invention relates to a process for making hydrogen gas, comprising:

(A) forming a water blended hydrocarbon feedstock composition comprising:

(i) a hydrocarbon feedstock;

(ii) water; and

(iii) at least one surfactant comprising:

(iii)(a) at least one product made from the reaction of an acylating agent with ammonia, an amine, an alcohol, or a mixture of two or more thereof;

(iii)(b) at least one product comprised of (I) a polycarboxylic acylating agent, and (II) a copolymer derived from at least one olefin monomer and at least one alpha, beta unsaturated carboxylic acid or derivative thereof linked together by (III) a linking group derived from a compound having two or more primary amino groups, two or more secondary amino groups, at least one primary amino group and at least one secondary amino group, at least two hydroxyl groups, or at least one primary or secondary amino group and at least one hydroxyl group;

(iii)(c) at least one aromatic Mannich derived from a hydroxy aromatic compound, an aldehyde or a ketone, and an amine containing at least one primary or secondary amino group;

(iii)(d) at least one ionic or a nonionic compound having a hydrophilic-lipophilic balance of about 1 to about 40; or

(iii)(e) mixture of two or more of (iii)(a) through (iii)(d); and

(B) steam reforming the water blended hydrocarbon feedstock composition formed in step (A) to convert the water blended hydrocarbon feedstock composition to a product comprising hydrogen and one or more carbon oxides.

### TECHNICAL FIELD

This invention relates to a process for making hydrogen gas from a hydrocarbon source. More particularly, this invention relates to a process for making hydrogen gas using a water blended hydrocarbon feedstock composition as the hydrocarbon source.

### BACKGROUND OF THE INVENTION

A major source of hydrogen gas is from a process known as steam reforming, in which a hydrocarbon and water react over a catalyst to form hydrogen and carbon monoxide (Eqn. 1):

CₙH₂ₙ₊₂+nH₂O→nCO+(2n+1)H₂ (1)

A CO/H₂ mixture can be used as a feedstock, such as for a Fisher-Tropsch process (the reverse of reaction 1). If pure hydrogen of a hydrogen-enriched H₂/CO mixture is desired, the water-gas shift reaction (Eqn. 2) is added to the process.

nCO+nH₂O→nCO₂+nH₂ (2)

The net overall process (Eqn. 3) when these two are combined is the production of hydrogen from hydrocarbon:

CₙH₂ₙ₊₂+nH₂O→nCO₂+(3n+1)H₂ (3)

Pure hydrogen is required in many applications including hydrotreating and hydrocracking in refineries, commercial catalytic hydrogenation for high volume chemicals, fats and oils processing, other industrial processes, and for fuel cells. Besides being a critical component for the production of high-grade chemicals and clean-burning fuels, hydrogen is, itself, the cleanest, highest energy content fuel on a weight basis. However, because hydrogen is a very explosive gas, its use has been limited by the need for supplying it in high-pressure cylinders.

The problem is to provide a process that can produce hydrogen efficiently and on-demand from available hydrocarbon feedstocks. This problem has been overcome with the present invention which involves steam reforming a water blended hydrocarbon feedstock composition to produce hydrogen. At least in one embodiment of the present invention, it has been discovered that by forming a water blended hydrocarbon feedstock composition prior to steam reforming, the efficiency of the steam reforming process and the purity of the hydrogen that is produced are significantly improved. This was unexpected.

### SUMMARY OF THE INVENTION

This invention relates to a process for making hydrogen gas, comprising:

(A) forming a water blended hydrocarbon feedstock composition comprising:

(i) a hydrocarbon feedstock;

(ii) water; and

(iii) at least one surfactant comprising:

(iii)(a) at least one product made from the reaction of an acylating agent with ammonia, an amine, an alcohol, or a mixture of two or more thereof;

(iii)(b) at least one product comprised of (I) a polycarboxylic acylating agent, and (II) a copolymer derived from at least one olefin monomer and at least one alpha, beta unsaturated carboxylic acid or derivative thereof linked together by (III) a linking group derived from a compound having two or more primary amino groups, two or more secondary amino groups, at least one primary amino group and at least one secondary amino group, at least two hydroxyl groups, or at least one primary or secondary amino group and at least one hydroxyl group;

(iii)(c) at least one aromatic Mannich derived from a hydroxy aromatic compound, an aldehyde or a ketone, and an amine containing at least one primary or secondary amino group;

(iii)(d) at least one ionic or a nonionic compound having a hydrophilic-lipophilic balance of about 1 to about 40; or

(iii)(e) mixture of two or more of (iii)(a) through (iii)(d); and

(B) steam reforming the water blended hydrocarbon feedstock composition formed in step (A) to convert the water blended hydrocarbon feedstock composition to a product comprising hydrogen and one or more carbon oxides.

In one embodiment, the water blended hydrocarbon feedstock composition formed during step (A) further comprises (iv) at least one water-soluble salt.

In one embodiment, prior to step (B) the water blended hydrocarbon feedstock composition formed in step (A) is partially oxidized to increase the temperature of the water blended hydrocarbon feedstock composition to a level sufficient for steam reforming.

In one embodiment, the invention provides for a process for treating a refinery stream comprising hydrocracking, hydrorefining, hydrotreating or hydrodesulfurizing the refinery stream using hydrogen made by the inventive process.

In one embodiment, the invention provides for a process comprising synthesing ammonia, hydrogenating an aromatic compound, hydroforming olefinic hydrocarbons to convert the olefinic hydrocarbons to branced-chain paraffins, making alcohols from synthesis gas, or hydrogenating a fat or an oil, using hydrogen made by the inventive process.

In one embodiment, the invention provides for a process comprising operating a fuel cell using hydrogen made by the inventive process.

### DETAILED DESCRIPTION OF THE INVENTION

The terms “hydrocarbon,” “hydrocarbyl,” and “hydrocarbon-based,” when referring to groups attached to the remainder of a molecule, refer to groups having a purely hydrocarbon or predominantly hydrocarbon character within the context of this invention. Such groups include the following:

(1) Purely hydrocarbon groups; that is, aliphatic, (e.g., alkyl or alkenyl), alicyclic (e.g., cycloalkyl or cycloalkenyl), aromatic, aliphatic- and alicyclic-substituted aromatic, aromatic-substituted aliphatic and alicyclic groups, and the like, as well as cyclic groups wherein the ring is completed through another portion of the molecule (that is, any two indicated substituents may together form an alicyclic group). Such groups are known to those skilled in the art. Examples include methyl, ethyl, octyl, decyl, octadecyl, cyclohexyl, phenyl, etc.

(2) Substituted hydrocarbon groups; that is, groups containing non-hydrocarbon substituents which do not alter the predominantly hydrocarbon character of the group. Those skilled in the art will be aware of suitable substituents. Examples include hydroxy, nitro, cyano, alkoxy, acyl, etc.

(3) Hetero groups; that is, groups which, while predominantly hydrocarbon in character, contain atoms other than carbon in a chain or ring otherwise composed of carbon atoms. Suitable hetero atoms will be apparent to those skilled in the art and include, for example, nitrogen, oxygen and sulfur.

In general, no more than about three substituents or hetero atoms, and in one embodiment no more than one, will be present for each 10 carbon atoms in the hydrocarbon, hydrocarbyl or hydrocarbon-based group.

Terms such as “alkyl-based,” “aryl-based,” and the like have meanings analogous to the above with respect to alkyl groups, aryl groups and the like.

The term “lower” as used herein in conjunction with terms such as hydrocarbon, alkyl, alkenyl, alkoxy, and the like, is intended to describe such groups which contain a total of up to 7 carbon atoms.

The term “oil-soluble” refers to a material that is soluble in mineral oil to the extent of at least about 0.5 gram per liter at 25° C.

The term “water-soluble” refers to materials that are soluble in water to the extent of at least 0.5 gram per 100 milliliters of water at 25° C.

### Step (A)

The water blended hydrocarbon feedstock composition that is formed during step (A) is comprised of (i) a hydrocarbon feedstock, (ii) water, and (iii) at least one surfactant. In one embodiment, the water blended hydrocarbon feedstock composition further comprises (iv) a water-soluble salt. The water blended hydrocarbon feedstock composition may be in the form of an emulsion. The emulsion may be a water-in-oil emulsion, an oil-in-water emulsion, or a micro-emulsion. Throughout the specification and in the claims the term “oil” is used to refer to a phase that is formed when the water blended hydrocarbon feedstock composition is formed, and it is to be understood that this term refers to any of the hydrocarbon feedstocks, including oils and normally liquid hydrocarbon fuels, discussed below. In one embodiment, the water blended hydrocarbon feedstock composition is characterized by a dispersed phase, the dispersed phase being comprised of droplets having a mean diameter of about 0.05 to about 50 microns, and in one embodiment about 0.05 to about 30 microns, and in one embodiment about 0.05 to about 15 microns, and in one embodiment about 0.05 to about 10 microns, and in one embodiment about 0.05 to about 5 microns, and in one embodiment about 0.05 to about 3 microns, and in one embodiment, 0.05 to about 1 micron, and in one embodiment about 0.05 to about 0.9 micron, and in one embodiment about 0.05 to about 0.7 micron, and in one embodiment about 0.1 to about 0.7 microns. In one embodiment, the dispersed phase is an aqueous phase. In one embodiment, the dispersed phase is an oil phase.

The Hydrocarbon Feedstock (i)

The hydrocarbon feedstock may be a natural oil, synthetic oil or mixture thereof. The natural oils include animal oils and vegetable oils (e.g., castor oil, lard oil) as well as mineral oils such as liquid petroleum oils and solvent treated or acid-treated mineral oils of the paraffinic, naphthenic or mixed paraffinic—naphthenic types. Oils derived from coal or shale are also useful. Synthetic oils include hydrocarbon oils such as polymerized and interpolymerized olefins (e.g., polybutylenes, polypropylenes, propylene isobutylene copolymers, etc.); poly(1-hexenes), poly-(1-octenes), poly(1-decenes), etc. and mixtures thereof; alkylbenzenes (e.g., dodecylbenzenes, tetradecylbenzenes, dinonylbenzenes, di-(2-ethylhexyl)benzenes, etc.); polyphenyls (e.g., biphenyls, terphenyls, alkylated polyphenyls, etc.); alkylated diphenyl ethers and alkylated diphenyl sulfides and the derivatives, analogs and homologs thereof and the like.

Alkylene oxide polymers and interpolymers and derivatives thereof where the terminal hydroxyl groups have been modified by esterification, etherification, etc., constitute another class of known synthetic oils that can be used as the hydrocarbon feedstock. These are exemplified by the oils prepared through polymerization of ethylene oxide or propylene oxide, the alkyl and aryl ethers of these polyoxyalkylene polymers (e.g., methyl-polyisopropylene glycol ether having an average molecular weight of about 1000, diphenyl ether of polyethylene glycol having a molecular weight of about 500-1000, diethyl ether of polypropylene glycol having a molecular weight of about 1000-1500, etc.) or mono- and polycarboxylic esters thereof, for example, the acetic acid esters, mixed C₃₋₈ fatty acid esters, or the C₁₃Oxo acid diester of tetraethylene glycol.

The synthetic oils that are useful as the hydrocarbon feedstock include the esters of dicarboxylic acids (e.g., phthalic acid, succinic acid, alkyl succinic acids, alkenyl succinic acids, maleic acid, azelaic acid, suberic acid, sebacic acid, fumaric acid, adipic acid, linoleic acid dimer, malonic acid, alkyl malonic acids, alkenyl malonic acids, etc.) with a variety of alcohols (e.g., butyl alcohol, hexyl alcohol, dodecyl alcohol, 2-ethylhexyl alcohol, ethylene glycol, diethylene glycol monoether, propylene glycol, etc.) Specific examples of these esters include dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, the 2-ethylhexyl diester of linoleic acid dimer, the complex ester formed by reacting one mole of sebacic acid with two moles of tetraethylene glycol and two moles of 2-ethylhexanoic acid and the like.

Esters useful as the hydrocarbon feedstock also include those made from C₅ to C₁₂ monocarboxylic acids and polyols and polyol ethers such as neopentyl glycol, trimethylol propane, pentaerythritol, dipentaerythritol, tripentaerythritol, etc.

The hydrocarbon feedstock may be a poly-alpha-olefin (PAO). Typically, the poly-alpha-olefins are derived from monomers having from about 4 to about 30, and in one embodiment from about 4 to about 20, and in one embodiment from about 6 to about 16 carbon atoms. Examples of useful PAOs that may be used include those derived from octene, decene, mixtures thereof, and the like. These PAOs may have a viscosity from about 2 to about 15, and in one embodiment from about 3 to about 12, and in one embodiment from about 4 to about 8 cSt at 100° C. Mixtures of mineral oil with the foregoing poly-alpha-olefins may be used.

The hydrocarbon feedstock may be comprised of Fischer-Tropsch synthesized hydrocarbons. Fischer-Tropsch synthesized hydrocarbons are made from synthesis gas containing H₂ and CO using a Fischer-Tropsch catalyst. These hydrocarbons may be further processed. For example, the hydrocarbons may be hydroisomerized using the process disclosed in U.S. Pat. Nos. 6,103,099 or 6,180,575; hydrocracked and hydroisomerized using the process disclosed in U.S. Pat. Nos. 4,943,672 or 6,096,940; dewaxed using the process disclosed in U.S. Pat. No. 5,882,505; or hydroisomerized and dewaxed using the process disclosed in U.S. Pat. Nos. 6,013,171, 6,080,301 or 6,165,949. These patents are incorporated herein by reference for their disclosures of processes for treating Fischer-Tropsch synthesized hydrocarbons and the resulting products made from such processes.

The hydrocarbon feedstock may be an unrefined, refined or rerefined oil. These may be either natural or synthetic oils (as well as mixtures of two or more of any of these) of the type disclosed hereinabove. Unrefined oils are those obtained directly from a natural or synthetic source without further purification treatment. For example, a shale oil obtained directly from retorting operations, a petroleum oil obtained directly from primary distillation or ester oil obtained directly from an esterification process and used without further treatment would be unrefined oils. Refined oils are similar to the unrefined oils except they have been further treated in one or more purification steps to improve one or more properties. Many such purification techniques are known to those skilled in the art such as solvent extraction, secondary distillation, acid or base extraction, filtration, percolation, etc. Rerefined oils are obtained by processes similar to those used to obtain refined oils applied to refined oils which have been already used in service. Such rerefined oils are also known as reclaimed or reprocessed oils and often are additionally processed by techniques directed to removal of spent additives and oil breakdown products.

The hydrocarbon feedstock may be obtained from a process stream generated during oil refining, chemical synthesis, and the like. For example, the hydrocarbon feedstock may be obtained from a middle distillate stream produced during oil refining.

The hydrocarbon feedstock may be a normally liquid hydrocarbon fuel.

These include distillate fuels such as motor gasoline as defined by ASTM Specification D439 or diesel fuel or fuel oil as defined by ASTM Specification D396. Normally liquid hydrocarbon fuels derived from vegetable sources, mineral sources, and mixtures thereof may be used. These include hydrocarbon fuels derived from corn, alfalfa, soybean, rapeseed, palm, shale, coal, tar sands, bitumen, residual oil, heavy oil, coke, and mixtures of two or more thereof.

The gasolines that can be used include those comprised of mixtures of hydrocarbons having an ASTM distillation range from about 60° C. at the 10% distillation point to about 205° C. at the 90% distillation point.

The diesel fuels that are useful may be any diesel fuel. These include the diesel fuels having a 90% point distillation temperature in the range of about 300° C. to about 390° C., and in one embodiment about 330° C. to about 350° C. The viscosity for these fuels typically ranges from about 1.3 to about 24 centistokes at 40° C. The diesel fuels can be classified as any of Grade Nos. 1-D, 2-D or 4-D as specified in ASTM D975.

The hydrocarbon feedstock may be comprised of a gaseous hydrocarbon dispersed or dissolved in a liquid hydrocarbon. The liquid hydrocarbon may be any of the above mentioned liquid hydrocarbons. The liquid hydrocarbon may be a normally liquid hydrocarbon fuel. The gaseous hydrocarbon may be a hydrocarbon having 1 to about 5 carbon atoms per molecule. The gaseous hydrocarbon may be methane (or natural gas).

The hydrocarbon feedstock may be present in the water blended hydrocarbon feedstock composition formed during step (A) at a concentration of about 0.1 to about 99.9% by weight, and in one embodiment about 1 to about 99% by weight, and in one embodiment about 5 to about 99% by weight, and in one embodiment about 10 to about 97% by weight, and in one embodiment about 20 to about 96% by weight, and in one embodiment about 30 to about 90% by weight, and in one embodiment about 40 to about 90% by weight, and in one embodiment about 50 to about 85% by weight.

The Water (ii)

The water (ii) used in forming the water blended hydrocarbon feedstock composition may be taken from any convenient source. In one embodiment, the water is deionized prior to being mixed with the hydrocarbon feedstock and surfactant. In one embodiment, the water is purified using reverse osmosis or distillation.

The water may be present in the water blended hydrocarbon feedstock composition formed during step (A) at a concentration of about 99.9 to about 0.1% by weight, and in one embodiment about 99 to about 1% by weight, and in one embodiment about 95 to about 1% by weight, and in one embodiment about 90 to about 3% by weight, and in one embodiment about 80 to about 4% by weight, and in one embodiment about 70 to about 10% by weight, and in one embodiment about 60 to about 10% by weight, and in one embodiment about 50 to about 15% by weight.

The Surfactant (iii)

The surfactant (iii) may be: (iii)(a) at least one product made from the reaction of an acylating agent with ammonia, an amine, an alcohol, or a mixture of two or more thereof; (iii)(b) at least one product derived from an acylating agent, ammonia or an amine, and a polymer containing units derived from an alpha, beta-unsaturated carboxylic acid or derivative thereof; (iii)(c) at least one aromatic Mannich derived from a hydroxy aromatic compound, an aldehyde or a ketone, and an amine containing at least one primary or secondary amino group; (iii)(d) at least one ionic or a nonionic compound having a hydrophilic-lipophilic balance of about 1 to about 40; or (iii)(e) mixture of two or more of (iii)(a) through (iii)(d). In embodiments wherein the composition formed during step (A) is in the form of an emulsion, these surfactants may function as emulsifiers and may be referred to as emulsifiers.

The surfactant (iii) is provided for the purpose of holding the mixture of water and hydrocarbon feedstock formed during step (A) of the inventive process together in the form of a stable dispersion, suspension or emulsion. The surfactant (iii) may be referred to as an emulsifier. The surfactant (iii) may be present in the water blended hydrocarbon feedstock composition in a minor emulsifying amount. The concentration may range from about 0.01 to about 20% by weight, and in one embodiment about 0.05 to about 10% by weight, and in one embodiment about 0.1 to about 5% by weight, and in one embodiment about 0.1 to about 3% by weight based on the weight of the water blended hydrocarbon feedstock composition.

Surfactant (iii)(a)

The surfactant (iii)(a) is the product made by reacting an acylating agent with ammonia, an amine, an alcohol, or a mixture of two or more thereof. The acylating agent may be a carboxylic acid or a reactive equivalent thereof. The carboxylic acid may be monobasic or polybasic. The polybasic acids include dicarboxylic acids, although tricarboxylic and tetracarboxylic acids may be used. The reactive equivalent may be an acid halide, anhydride or ester, including partial esters, and the like. The acylating agent may be a carboxylic acid or reactive equivalent containing at least one hydrocarbon substituent. The hydrocarbon substituent may contain from about 6 to about 500 carbon atoms, and in one embodiment about 10 to about 500 carbon atoms, and in one embodiment about 12 to about 500 carbon atoms, and in one embodiment about 16 to about 500 carbon atoms, and in one embodiment about 20 to about 500 carbon atoms, and in one embodiment about 30 to about 500 carbon atoms, and in one embodiment 50 to about 500 carbon atoms, and in one embodiment about 50 to about 250 carbon atoms. In one embodiment, the hydrocarbon substituent has a number average molecular weight of about 750 to about 3000, and in one embodiment about 900 to about 2000.

The acylating agent may be a carboxylic acid or reactive equivalent thereof having about 10 to about 34 carbon atoms, and in one embodiment about 12 to about 24 carbon atoms, and in one embodiment about 12 to about 20 carbon atoms. These acylating agents may be monobasic acids, polybasic acids, or reactive equivalents of such mono- or polybasic acids. The monobasic acids include fatty acids. Examples include lauric acid, myristic acid, palmitic acid, stearic acid, oleic acid, linoleic acid, linolenic acid,arachidic acid, behenic acid, erucic acid, lignoceric acid, and the like. The polybasic acids may be dicarboxylic, although tricarboxylic or tetracarboxylic acids may be used. These include hydrocarbon substituted succinic acids or anhydrides represented, respectively, by the formulae

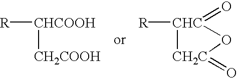

wherein each of the foregoing formulae R is a hydrocarbon group of about 6 to about 30 carbon atoms, and in one embodiment about 10 to about 30 carbon atoms, and in one embodiment about 12 to about 30 carbon atoms, and in one embodiment about 12 to about 24 carbon atoms, and in one embodiment about 12 to about 18 carbon atoms. R may be derived from an alpha-olefin or an alpha-olefin fraction. The alpha-olefins include dodecene-1, tridecene-1, tetradecene-1, pentadecene-1, hexadecene-1, heptadecene-1, octadecene-1, eicosene-1, docosene-1, triacontene-1, and the like. The alpha olefin fractions include C₁₅₋₁₈ alpha-olefins, C₁₂₋₁₆ alpha-olefins, C₁₄₋₁₆ alpha-olefins, C₁₄₋₁₈ alpha-olefins, C₁₆₋₁₈ alpha-olefins, C₁₈₋₂₄ alpha-olefins, C₁₈₋₃₀ alpha-olefins, and the like. Mixtures of two or more of any of the foregoing alpha-olefins or alpha-olefin fractions may be used. Examples of useful acylating agents include propylene tetramer substituted succinic acid or anhydride, hexadecenyl succinic acid or anhydride, and the like.

The acylating agent may be a hydrocarbon substituted carboxylic acid or reactive equivalent made by reacting one or more alpha, beta olefinically unsaturated carboxylic acid reagents containing 2 to about 20 carbon atoms, exclusive of the carboxyl groups, with one or more olefin polymers.

The alpha-beta olefinically unsaturated carboxylic acid reagents may be either monobasic or polybasic in nature. Exemplary of the monobasic alpha-beta olefinically unsaturated carboxylic acid reagents include the carboxylic acids corresponding to the formula

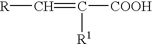

wherein R is hydrogen, or a saturated aliphatic or alicyclic, aryl, alkylaryl or heterocyclic group, and R¹ is hydrogen or a lower alkyl group. R may be a lower alkyl group. The total number of carbon atoms in R and R¹ typically does not exceed about 18 carbon atoms. Specific examples of useful monobasic alpha-beta olefinically unsaturated carboxylic acids include acrylic acid; methacrylic acid; cinnamic acid; crotonic acid; 3-phenyl propenoic acid; alpha, and beta-decenoic acid. The polybasic acid reagents may be dicarboxylic, although tri- and tetracarboxylic acids can be used. Exemplary polybasic acids include maleic acid, fumaric acid, mesaconic acid, itaconic acid and citraconic acid. Reactive equivalents of the alpha-beta olefinically unsaturated carboxylic acid reagents include the anhydride, ester or amide functional derivatives of the foregoing acids. A useful reactive equivalent is maleic anhydride.

The olefin monomers from which the olefin polymers may be derived are polymerizable olefin monomers characterized by having one or more ethylenic unsaturated groups. They can be monoolefinic monomers such as ethylene, propylene, butene-1, isobutene and octene-1 or polyolefinic monomers (usually di-olefinic monomers such as butadiene-1,3 and isoprene). Usually these monomers are terminal olefins, that is, olefins characterized by the presence of the group>C═CH₂. However, certain internal olefins can also serve as monomers (these are sometimes referred to as medial olefins). When such medial olefin monomers are used, they normally are employed in combination with terminal olefins to produce olefin polymers that are interpolymers. Although, the olefin polymers may also include aromatic groups (such as phenyl groups and lower alkyl and/or lower alkoxy-substituted phenyl groups (e.g., para(tertiary-butyl)-phenyl groups)) and alicyclic groups such as would be obtained from polymerizable cyclic olefins or alicyclic-substituted polymerizable cyclic olefins, the olefin polymers are usually free from such groups. Nevertheless, olefin polymers derived from such interpolymers of both 1,3-dienes and styrenes such as butadiene-1,3 and styrene or para-(tertiary butyl) styrene are exceptions to this general rule.

Generally the olefin polymers are homo- or interpolymers of terminal hydrocarbon olefins of about 2 to about 30 carbon atoms, and in one embodiment about 2 to about 16 carbon atoms. A more typical class of olefin polymers is selected from that group consisting of homo- and interpolymers of terminal olefins of 2 to about 6 carbon atoms, and in one embodiment 2 to about 4 carbon atoms.

Specific examples of terminal and medial olefin monomers which can be used to prepare the olefin polymers include ethylene, propylene, butene-1, butene-2, isobutene, pentene-1, hexene-1, heptene-1, octene-1, nonene-1, decene-1, pentene-2, propylene tetramer, diisobutylene, isobutylene trimer, butadiene-1,2, butadiene-1,3, pentadiene-1,2, pentadiene-1,3, isoprene, hexadiene-1,5, 2-chlorobutadiene-1,3, 2-methylheptene-1, 3-cyclohexylbutene-1, 3,3-dimethylpentene-1, styrenedivinylbenzene, vinyl-acetate allyl alcohol, 1-methylvinylacetate, acrylonitrile, ethyl acrylate, ethylvinylether and methyl-vinylketone. Of these, the purely hydrocarbon monomers are more typical and the terminal olefin monomers may be useful.

In one embodiment, the olefin polymers are polyisobutenes (or polyisobutylenes) such as those obtained by polymerization of a C₄ refinery stream having a butene content of about 35 to about 75% by weight and an isobutene content of about 30 to about 60% by weight in the presence of a Lewis acid catalyst such as aluminum chloride or boron trifluoride. These polyisobutylenes generally contain predominantly (that is, greater than about 50 percent of the total repeat units) isobutene repeat units of the configuration

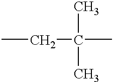

The olefin polymer may be a polyisobutene having a high methylvinylidene isomer content, that is, at least about 50% by weight, and in one embodiment at least about 70% by weight methylvinylidenes. Suitable high methylvinylidene polyisobutenes include those prepared using boron trifluoride catalysts. The preparation of such polyisobutenes in which the methylvinylidene isomer comprises a high percentage of the total olefin composition is described in U.S. Pat. Nos. 4,152,499 and 4,605,808, the disclosure of each of which are incorporated herein by reference.

The acylating agent may be a hydrocarbon-substituted succinic acid or anhydride represented, correspondingly, by the formulae

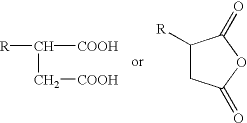

wherein R is hydrocarbon group of about 6 to about 500 carbon atoms, and in one embodiment about 12 to about 500 carbon atoms, and in one embodiment about 20 to about 500 carbon atoms, and in one embodiment about 30 to about 500 carbon atoms, and in one embodiment about 40 to about 500 carbon atoms, and in one embodiment from about 50 to about 500, and in one embodiment from about 50 to about 250 carbon atoms. In one embodiment, R is a polyisobutene group (or polyisobutylene group). R may have a number average molecular weight of about 750 to about 3000, and in one embodiment about 900 to about 2000. The production of these hydrocarbon-substituted succinic acids or anhydrides via alkylation of maleic acid or anhydride or its derivatives with a halohydrocarbon or via reaction of maleic acid or anhydride with an olefin polymer having a terminal double bond is well known to those of skill in the art and need not be discussed in detail herein.

In one embodiment, the hydrocarbon-substituted succinic acids or anhydrides are characterized by the presence within their structure of an average of at least about 1.3 succinic groups, and in one embodiment from about 1.5 to about 2.5, and in one embodiment form about 1.7 to about 2.1 succinic groups for each equivalent weight of the hydrocarbon substituent.

For purposes of this invention, an equivalent weight of the hydrocarbon substituent group of the hydrocarbon-substituted succinic acid or anhydride is the number obtained by dividing the number average molecular weight (Mₙ) of the polyolefin from which the hydrocarbon substituent is derived into the total weight of all the hydrocarbon substituent groups present in the hydrocarbon-substituted succinic acids or anhydrides. Thus, if a hydrocarbon-substituted succinic acid or anhydride is characterized by a total weight of all hydrocarbon substituents of 40,000 and the Mₙ value for the polyolefin from which the hydrocarbon substituent groups are derived is 2000, then that substituted succinic acid or anhydride is characterized by a total of 20 (40,000/2000=20) equivalent weights of substituent groups.

The ratio of succinic groups to equivalent of substituent groups present in the hydrocarbon-substituted succinic acylating agent (also called the “succination ratio”) can be determined by one skilled in the art using conventional techniques (such as from saponification or acid numbers). For example, the formula below can be used to calculate the succination ratio where maleic anhydride is used in the acylation process:

$$SR = \frac{{M}_{n} \times ( Sap . No . of acylating agent )}{( 56100 \times 2 ) - ( 98 \times Sap . No . of acylating agent )}$$

In this equation, SR is the succination ratio, Mₙ is the number average molecular weight, and Sap. No. is the saponification number. In the above equation, Sap. No. of acylating agent=measured Sap. No. of the final reaction mixture/Al wherein Al is the active ingredient content expressed as a number between 0 and 1, but not equal to zero. Thus an active ingredient content of 80% corresponds to an Al value of 0.8. The Al value can be calculated by using techniques such as column chromatography which can be used to determine the amount of unreacted polyalkene in the final reaction mixture. As a rough approximation, the value of Al is determined after subtracting the percentage of unreacted polyalkene from 100.

The conditions, i.e., temperature, agitation, solvents, and the like, for reacting an alpha, beta olefinically unsaturated carboxylic acid reagent with an olefin polymer, are known to those in the art. Examples of patents describing various procedures for preparing useful acylating agents include U.S. Pat. Nos. 3,215,707; 3,219,666; 3,231,587; 3,912,764; 4,110,349; and 4,234,435;

and U.K. Patent 1,440,219. The disclosures of these patents are hereby incorporated by reference.

The acylating agent may be comprised of (I) a first carboxylic acylating agent having at least one hydrocarbon substituent of about 6 to about 500 carbon atoms, and (II) a second carboxylic acylating agent optionally having at least one hydrocarbon substituent of up to about 500 carbon atoms. The acylating agents (I) and (II) may be monobasic, polybasic, or a mixture thereof. These acylating agents may be mixed together, or they may be linked together through a linking group (III). The weight ratio of (I):(II) may be from about 5:95 to about 95:5, and in one embodiment about 25:75 to about 75:25, and in one embodiment about 40:60 to about 60:40.

In the embodiment wherein the acylating agents (I) and (II) are linked together by a linking group (III) the acylating agents (I) and (II) are polybasic and the linking group is derived from a compound having two or more primary amino groups, two or more secondary amino groups, at least one primary amino group and at least one secondary amino group, at least two hydroxyl groups, or at least one primary or secondary amino group and at least one hydroxyl groups.

The hydrocarbon substituent of the first acylating agent (I) may have about 12 to about 500 carbon atoms, and in one embodiment about 20 to about 500 carbon atoms, and in one embodiment about 30 to about 500 carbon atoms, and in one embodiment about 40 to about 500 carbon atoms, and in one embodiment about 50 to about 500 carbon atoms.

In the embodiment wherein the acylating agents (I) and (II) are linked together the optional hydrocarbon substituent of the second acylating agent (II) may have 1 to about 500 carbon atoms, and in one embodiment about 6 to about 500 carbon atoms, and in one embodiment about 12 to about 500 carbon atoms, and in one embodiment about 18 to about 500 carbon atoms, and in one embodiment about 24 to about 500 carbon atoms, and in one embodiment about 30 to about 500 carbon atoms, and in one embodiment about 40 to about 500 carbon atoms, and in one embodiment about 50 to about 500 carbon atoms. In the embodiment wherein the acylating agents (I) and (II) are merely mixed together the hydrocarbon substituent of the acylating agent (II) must be of sufficient length to provide the acylating agent with oil solubility, typically the hydrocarbon substituent will have at least about 6 carbon atoms, and in one embodiment at least about 12 carbon atoms.

In one embodiment, each of the hydrocarbon substituents of each of the acylating agents (I) and (II) is a polyisobutene group, and each polyisobutene group independently has a number average molecular weight in the range of about 500 to about 3000, and in one embodiment about 700 to about 2600. The hydrocarbon substituent of the acylating agent (I) may be a polyisobutene group having a number average molecular weight of about 2000 to about 2600, and in one embodiment about 2200 to about 2400, and in one embodiment about 2300. The hydrocarbon substituent of the acylating agent (II) may be a polyisobutene group having a number average molecular weight of about 700 to about 1300, and in one embodiment about 900 to about 1100, and in one embodiment about 1000.

The linking group (III) for linking the first acylating agent (I) with the second acylating agent (II) may be derived from a polyol, a polyamine or a hydroxyamine. The polyol may be a compound represented by the formula

R—(OH)ₘ

wherein in the foregoing formula, R is an organic group having a valency of m, R is joined to the OH groups through carbon-to-oxygen bonds, and m is an integer from 2 to about 10, and in one embodiment 2 to about 6. R may be a hydrocarbon group of 1 to about 40 carbon atoms, and in one embodiment 1 to about 20 carbon atoms. The polyol may be a glycol. The alkylene glycols are useful. Examples of the polyols that may be used include ethylene glycol, diethylene glycol, triethylene glycol, tetraethylene glycol, propylene glycol, dipropylene glycol, tripropylene glycol, dibutylene glycol, tributylene glycol, 1,2-butanediol, 2,3-dimethyl-2,3-butanediol, 2,3-hexanediol, 1,2-cyclohexanediol, pentaerythritol, dipentaerythritol, 1,7-heptanediol, 2,4-heptanediol, 1,2,3-hexanetriol, 1,2,4-hexanetriol, 1,2,5-hexanetriol, 2,3,4-hexanetriol, 1,2,3-butanetriol, 1,2,4-butanetriol, 2,2,6,6-tetrakis-(hydroxymethyl) cyclohexanol, 1,10-decanediol, digitalose, 2-hydroxymethyl-2-methyl-1,3-propanediol-(tri-methylethane), or 2-hydroxymethyl-2-ethyl-1,3-propanediol-(trimethylpropane), and the like. Mixtures of two or more of the foregoing can be used.

The polyamines useful as linking compounds (III) for linking the acylating agents (I) and (II) may be aliphatic, cycloaliphatic, heterocyclic or aromatic compounds. These include the alkylene polyamines represented by the formula:

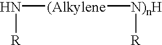

wherein n has an average value between 1 and about 10, and in one embodiment about 2 to about 7, the “Alkylene” group has from 1 to about 10 carbon atoms, and in one embodiment about 2 to about 6 carbon atoms, and each R is independently hydrogen, an aliphatic or hydroxy-substituted aliphatic group of up to about 30 carbon atoms. These alkylene polyamines include methylene polyamines, ethylene polyamines, butylene polyamines, propylene polyamines, pentylene polyamines, etc. Specific examples of such polyamines include ethylene diamine, triethylene tetramine, propylene diamine, trimethylene diamine, tripropylene tetramine, tetraethylene pentamine, hexaethylene heptamine, pentaethylene hexamine, or a mixture of two or more thereof.

The hydroxyamines useful as linking compounds (III) for linking the acylating agents (I) and (II) may be primary or secondary amines. The terms “hydroxyamine” and “aminoalcohol” describe the same class of compounds and, therefore, can be used interchangeably. In one embodiment, the hydroxyamine is (a) an N-(hydroxyl-substituted hydrocarbon) amine, (b) a hydroxyl-substituted poly(hydrocarbonoxy) analog of (a), or a mixture of (a) and (b). The hydroxyamine may be an alkanol amine containing from 1 to about 40 carbon atoms, and in one embodiment 1 to about 20 carbon atoms, and in one embodiment 1 to about 10 carbon atoms.

The hydroxyamines useful as the linking compound (III) may be a primary or secondary amines, or a mixture of two or more thereof. These hydroxyamines may be represented, respectfully, by the formulae:

H₂N—R′—OH

or

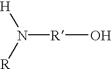

wherein each R is independently a hydrocarbon group of one to about eight carbon atoms or hydroxyl-substituted hydrocarbon group of two to about eight carbon atoms and R′ is a divalent hydrocarbon group of about two to about 18 carbon atoms. Typically each R is a lower alkyl group of up to seven carbon atoms. The group —R′—OH in such formulae represents the hydroxyl-substituted hydrocarbon group. R′ can be an acyclic, alicyclic or aromatic group. Typically, R′ is an acyclic straight or branched alkylene group such as an ethylene, 1,2-propylene, 1,2-butylene, 1,2-octadecylene, etc. group.

The hydroxyamines useful as the linking compound (III) may be ether N-(hydroxy-substituted hydrocarbon) amines. These may be hydroxyl-substituted poly(hydrocarbonoxy) analogs of the above-described hydroxyamines (these analogs also include hydroxyl-substituted oxyalkylene analogs). Such N-(hydroxyl-substituted hydrocarbon) amines may be conveniently prepared by reaction of epoxides with afore-described amines and may be represented by the formulae:

H₂N—R′—OH

or

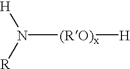

wherein x is a number from about 2 to about 15, and R and R′ are as described above.

The hydroxyamine useful as the linking compound (III) for linking the acylating agents (I) and (II) may be one of the hydroxy-substituted primary amines described in U.S. Pat. No. 3,576,743 by the general formula

Rₐ—NH₂

wherein Rₐ is a monovalent organic group containing at least one alcoholic hydroxy group. The total number of carbon atoms in Rₐ preferably does not exceed about 20. Hydroxy-substituted aliphatic primary amines containing a total of up to about 10 carbon atoms are useful. The polyhydroxy-substituted alkanol primary amines wherein there is only one amino group present (i.e., a primary amino group) having one alkyl substituent containing up to about 10 carbon atoms and up to about 6 hydroxyl groups are useful. These alkanol primary amines correspond to Rₐ—NH₂ wherein Rₐ is a mono-O or polyhydroxy-substituted alkyl group. It is desirable that at least one of the hydroxyl groups be a primary alcoholic hydroxyl group. Specific examples of the hydroxy-substituted primary amines include 2-amino-1-butanol,2-amino-2-methyl-1-propanol,p-(beta-hydroxyethyl)-aniline, 2-amino-1-propanol, 3-amino-1-propanol,2-amino-2-methyl-1,3-propanediol, 2-amino-2-ethyl-1,3-propanediol,N-(beta-hydroxypropyl)-N′-(beta-aminoethyl)-piperazine, tris-(hydroxymethyl) aminomethane (also known as trismethylolaminomethane),2-amino-1-butanol,ethanolamine,beta-(beta-hydroxye thoxy)-ethylamine, glucamine, glucosamine, 4-amino-3-hydroxy-3-methyl-1-butene (that can be prepared according to procedures known in the art by reacting isopreneoxide with ammonia), N-3(aminopropyl)-4-(2-hydroxyethyl)-piperadine, 2-amino-6-methyl-6-heptanol,5-amino-1-pentanol, N-(beta-hydroxyethyl)-1,3-diamino propane, 1,3-diamino-2-hydroxypropane, N-(beta-hydroxy ethoxyethyl)-ethylenediamine, trismethylol aminomethane and the like.

Hydroxyalkyl alkylene polyamines having one or more hydroxyalkyl substituents on the nitrogen atoms may be used as the linking compound (III) for linking the acylating agents (I) and (II). Useful hydroxyalkyl-substituted alkylene polyamines include those in which the hydroxyalkyl group is a lower hydroxyalkyl group, i.e., having less than eight carbon atoms. Examples of such hydroxyalkyl-substituted polyamines include N-(2-hydroxyethyl) ethylene diamine, N,N-bis(2-hydroxyethyl) ethylene diamine, 1-(2-hydroxyethyl)-piperazine, monohydroxypropyl-substituted diethylene triamine, dihydroxypropyl-substituted tetraethylene pentamine, N-(3-hydroxybutyl) tetramethylene diamine, etc. Higher homologs as are obtained by condensation of the above-illustrated hydroxy alkylene polyamines through amino groups or through hydroxy groups are likewise useful. Condensation through amino groups results in a higher amine accompanied by removal of ammonia and condensation through the hydroxy groups results in products containing ether linkages accompanied by removal of water.

The acylating agents (I) and (II) may be reacted with the linking compound (III) according to conventional ester and/or amide-forming techniques. This normally involves heating acylating agents (I) and (II) with the linking compound (III), optionally in the presence of a normally liquid, substantially inert, organic liquid solvent/diluent. Temperatures of at least about 30° C. up to the decomposition temperature of the reaction component and/or product having the lowest such temperature can be used. This temperature may be in the range of about 50° C. to about 130° C., and in one embodiment about 80° C. to about 100° C. when the acylating agents (I) and (II) are anhydrides. On the other hand, when the acylating agents (I) and (II) are acids, this temperature is typically in the range of about 100° C. to about 300° C. with temperatures in the range of about 125° C. to about 250° C. often being employed. The ratio of reactants may be varied over a wide range. Generally, for each equivalent of each of the acylating agents (I) and (II), at least about one equivalent of the linking compound (III) is used. The upper limit of linking compound (III) is about 2 equivalents of linking compound (III) for each equivalent of acylating agents (I) and (II). Generally the ratio of equivalents of acylating agent (I) to the acylating agent (II) is about 0.5 to about 2, with about 1:1 being useful. The product made by this reaction is typically in the form of statistical mixture that is dependent on the charge of each of the acylating agents (I) and (II), and on the number of reactive sites on the linking compound (III). For example, if an equal molar ratio of acylating agents (I) and (II) is reacted with ethylene glycol, the product would be comprised of a mixture of (1) 50% of compounds wherein one molecule the acylating agent (I) is linked to one molecule of the acylating agent (II) through the ethylene glycol; (2) 25% of compounds wherein two molecules of the acylating agent (I) are linked together through the ethylene glycol; and (3) 25% of compounds wherein two molecules of the acylating agent (II) are linked together through the ethylene glycol.

The amines which are useful for reacting with the acylating agent to form the surfactant (iii)(a) include the amines and hydroxyamines discussed above as being useful as linking compounds (III) for linking the acylating agents (I) and (II). Also included are primary and secondary monoamines, tertiary mono- and polyamines, and tertiary alkanol amines. The tertiary amines are analogous to the primary amines, secondary amines and hydroxyamines discussed above with the exception that they may be either monoamines or polyamines and the hydrogen atoms in at least one of the H—N<or —NH₂ groups are replaced by hydrocarbon groups.

The monoamines that are useful for reacting with the acylating agent to form the surfactant (iii)(a) may be represented by the formula

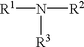

wherein R¹, R² and R³ are the same or different hydrocarbon groups. Preferably, R¹, R² and R³ are independently hydrocarbon groups of from 1 to about 20 carbon atoms, and in one embodiment from 1 to about 10 carbon atoms. Examples of useful tertiaryamines include trimethylamine, triethyl amine, tripropylamine, tributylamine, monomethyidiethylamine, monoethyldimethylamine, dimethylpropylamine, dimethylbutylamine, dimethylpentylamine, dimethylhexylamine, dimethylheptylamine, dimethyloctyl amine, dimethylnonyl amine, dimethyidecyl amine, dimethylphenyl amine, N,N-dioctyl-1-octanamine, N,N-didodecyl-1-dodecanamine, tricocoamine, trihydrogenated-tallowamine, N-methyl-dihydrogenated-tallowamine, N,N-dimethyl-1-dodecanamine, N,N-dimethyl-1-tetradecanamine, N,N-dimethyl-1-hexadecanamine, N,N-dimethyl 1-octadecanamine, N,N-dimethylcocoamine, N,N-dimethylsoyaamine, N,N-dimethylhydrogenated-tallowamine, etc.

Tertiary alkanol amines that are useful for reacting with the acylating agent to form the surfactant (iii)(a) include those represented by the formula:

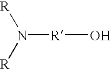

wherein each R is independently a hydrocarbon group of one to about eight carbon atoms or hydroxyl-substituted hydrocarbon group of two to about eight carbon atoms and R′ is a divalent hydrocarbon group of about two to about 18 carbon atoms. The groups —R′—OH in such formula represents the hydroxyl-substituted hydrocarbon groups. R′ may be an acyclic, alicyclic or aromatic group. Typically, R′ is an acyclic straight or branched alkylene group such as an ethylene, 1,2-propylene, 1,2-butylene, 1,2-octadecylene, etc. group. Where two R groups are present in the same molecule they can be joined by a direct carbon-to-carbon bond or through a heteroatom (e.g., oxygen, nitrogen or sulfur) to form a 5-, 6-, 7- or 8-membered ring structure. Examples of such heterocyclic amines include N-(hydroxyl lower alkyl)-morpholines,-thiomorpholines, -piperidines, -oxazolidines, -thiazolidines, and the like. Typically, however, each R is a low alkyl group of up to seven carbon atoms. A useful hydroxyamine is dimethylaminoethanol. The hydroxyamines can also be ether N-(hydroxy-substituted hydrocarbon)amines. These are hydroxyl-substituted poly(hydrocarbonoxy) analogs of the above-described hydroxy amines (these analogs also include hydroxyl-substituted oxyalkylene analogs). Such N-(hydroxyl-substituted hydrocarbon) amines can be conveniently prepared by reaction of epoxides with afore-described amines and can be represented by the formula:

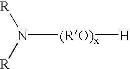

wherein x is a number from about 2 to about 15 and R and R′ are described above.

Polyamines which are useful for reacting with the acylating agent to form the surfactant (iii)(a) include the alkylene polyamines discussed above as well as alkylene polyamines with only one or no hydrogens attached to the nitrogen atoms. These include the polyamines represented by the formula:

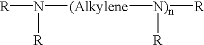

wherein n is from 1 to about 10, preferably from 1 to about 7; each R is independently a hydrogen atom, a hydrocarbon group or a hydroxy-substituted hydrocarbon group having up to about 700 carbon atoms, and in one embodiment up to about 100 carbon atoms, and in one embodiment up to about 50 carbon atoms, and in one embodiment up to about 30 carbon atoms; and the “Alkylene” group has from 1 to about 18 carbon atoms, and in one embodiment from 1 to about 6 carbon atoms.

The amines useful for reacting with the acylating agent to form the surfactant (iii)(a) include heavy polyamines. The term “heavy polyamine” refers to a polyamine having seven or more nitrogens per molecule and two or more primary amines per molecule. The heavy polyamines typically comprise mixtures of ethylene polyamines. They often result from the stripping of polyamine mixtures, to remove lower molecular weight polyamines and volatile components, to leave, as residue, what is often termed “polyamine bottoms”. In general, polyamine bottoms may be characterized as having less than about 2% by weight, and in one embodiment less than about 1% by weight, material boiling below about 200° C. In one embodiment, the heavy polyamine comprises ethylene polyamine bottoms which contain less than about 2% by weight diethylenetriamine (DETA) and triethylenetetramine (TETA), as set forth in U.S. Pat. No. 5,912,213 which incorporated herein by reference. A typical sample of such ethylene polyamine bottoms obtained from the Dow Chemical Company designated “E-100” has a specific gravity at 15.6° C. of 1.0168, a percent nitrogen by weight of 33.15 and a viscosity at 40° C. of 121 centistokes. Gas chromatography analysis of such a sample indicated that it contains about 0.93% “light ends” (most probably diethylenetriamine), 0.72% triethylene tetramine, 21.74% tetraethylenepentamine and 76.61% pentaethylenehexamine and higher (by weight). Another commercially available sample is from Union Carbide, known as HPA-X®. These polyamine bottoms often include cyclic condensation products such as piperazine and higher analogs of diethylenetriamine, triethylenetetramine and the like.

The alcohols which are useful for reacting with the acylating agent to form the surfactant (iii)(a) include the polyols discussed above as being useful as linking compounds (III) for linking the acylating agents (I) and (II). Also included are mono-alcohols. The mono-alcohols may contain from 1 to about 40 carbon atoms, and in one embodiment 1 to about 20 carbon atoms. Examples include methyl alcohol, ethyl alcohol, n-propyl alcohol, isopropyl alcohol, n-butyl alcohol, isobutyl alcohol, sec-butyl alcohol, tert-butyl alcohol, n-pentyl alcohol, isopentyl alcohol, tert-pentyl alcohol, cyclopentanol, n-hexyl alcohol, cyclohexanol, n-heptyl alcohol, n-octyl alcohol, n-decyl alcohol, n-dodecyl alcohol, n-tetradecyl alcohol, n-hexadecyl alcohol, n-octadecyl alcohol, allyl alcohol, crotyl alcohol, methylvinyl carbinol, benzyl alcohol, alpha-phenylethyl alcohol, beta-phenylethyl alcohol, diphenylcarbinol, triphenylcarbinol, cinnamyl alcohol, and mixtures of two or more thereof.

The alcohol may be a compound represented by the formula

RO(R¹O)ₙH

wherein R is hydrogen or a hydrocarbon group of 1 to about 40 carbon atoms, and in one embodiment 1 to about 20 carbon atoms; R¹ is an alkylene group of 1 to about 6 carbon atoms, and in one embodiment about 2 to about 4 carbon atoms; and n is a number in the range of about 1 to about 30, and in one embodiment about 6 to about 30. R may be a straight chain or branched chain alkyl or alkenyl group. R¹ may be a C₂, C₃ or C₄ alkylene group, or a mixture of two or more thereof.

The surfactant (iii)(a) may be in the form of a salt, an ester, an amide, an imide or a mixture of two or more thereof. The salt may be an internal salt involving residues of a molecule of the acylating agent and the ammonia or amine wherein one of the carboxyl groups becomes ionically bound to a nitrogen atom within the same group; or it may be an external salt wherein the ionic salt group is formed with a nitrogen atom that is not part of the same molecule. In one embodiment, the amine is a hydroxyamine, the acylating agent is a hydrocarbon substituted succinic anhydride, and the resulting surfactant (iii)(a) is a half ester and half salt, i.e., an ester/salt. In one embodiment, the surfactant (iii)(a) comprises a mixture of a salt or an ester/salt with an imide.

The reaction between the acylating agent and the ammonia, amine, alcohol or mixture thereof to form the surfactant (iii)(a) is carried out under conditions that provide for the formation of the desired product. Typically, the reaction is carried out at a temperature in the range of from about 50° C. to about 250° C., and in one embodiment from about 80° C. to about 200° C.; optionally in the presence of a normally liquid, substantially inert organic liquid solvent/diluent, until the desired product has formed. In one embodiment, the acylating agent and the ammonia, amine, alcohol, or mixture thereof, are reacted in amounts sufficient to provide from about 0.3 to about 3 equivalents of acylating agent per equivalent of ammonia, amine, alcohol, or mixture thereof. In one embodiment, this ratio is from about 0.5:1 to about 2:1, and in one embodiment about 1:1.

In one embodiment, the surfactant (iii)(a) may be prepared by initially reacting the acylating agents (I) and (II) with the linking compound (III) to form an intermediate, and thereafter reacting the intermediate with the ammonia, amine, alcohol, or mixture thereof, to form the desired product. An alternative method involves reacting the acylating agent (I) and ammonia, amine, alcohol, or mixture thereof, with each other to form a first product, separately reacting the acylating agent (II) and ammonia, amine, alcohol, or mixture thereof (which can be the same or different ammonia, amine, alcohol, or mixture thereof that is reacted with the acylating agent (I)) with each other to form a second product, then reacting a mixture of these two products with the linking compound (III). The ratio of reactants ultilized in the preparation of these products may be varied over a wide range. Generally, for each equivalent of each of the acylating agents (I) and (II), at least about one equivalent of the linking compound (III) is used. From about 0.1 to about 2 equivalents or more of ammonia, amine, alcohol, or mixture thereof are used for each equivalent of the acylating agents (I) and (II), respectively. The upper limit of linking compound (III) is about 2 equivalents of linking compound (III) for each equivalent of acylating agents (I) and (II). Generally the ratio of equivalents of acylating agent (I) to the acylating agent (II) is about 0.5 to about 2, with about 1:1 being useful. Useful amounts of the reactants include about 2 equivalents of the linking compound (III), and from about 0.1 to about 2 equivalents of the ammonia, amine, alcohol or mixture thereof for each equivalent of each of the acylating agents (I) and (I).

The number of equivalents of the acylating agents depends on the total number of carboxylic functions present in each. In determining the number of equivalents for each of the acylating agents, those carboxyl functions which are not capable of reacting as a carboxylic acid acylating agent are excluded. In general, however, there is one equivalent of acylating agent for each carboxy group in the acylating agent. For example, there would be two equivalents in an anhydride derived from the reaction of one mole of olefin polymer and one mole of maleic anhydride.

The weight of an equivalent of an amine is the molecular weight of the polyamine divided by the total number of nitrogens present in the molecule. If the amine is to be used as linking compound (III), tertiary amino groups are not counted. On the other hand, if the amine is used in the reaction with the acylating agent to form the surfactant (iii)(a), tertiary amino groups are counted. The weight of an equivalent of a commercially available mixture of polyamines can be determined by dividing the atomic weight of nitrogen (14) by the % N contained in the polyamine; thus, a polyamine mixture having a % N of 34 would have an equivalent weight of 41.2. The weight of an equivalent of ammonia or a monoamine is equal to its molecular weight.

The weight of an equivalent of an alcohol is its molecular weight divided by the total number of hydroxyl groups present in the molecule. Thus, the weight of an equivalent of ethylene glycol is one-half its molecular weight.

The weight of an equivalent of a hydroxyamine which is to be used as a linking compound (III) is equal to its molecular weight divided by the total number of —OH, >NH and —NH₂ groups present in the molecule. On the other hand, if the hydroxyamine is to be used in the reaction with the acylating agent to form the surfactant (iii)(a), the weight of an equivalent thereof would be its molecular weight divided by the total number of nitrogen groups present in the molecule.

In one embodiment, the surfactant (iii)(a) is the product made by the reaction of a hydrocarbon-substituted carboxylic acid or reactive equivalent thereof with ammonia, an amine, an alcohol, or a mixture of two or more thereof, the hydrocarbon substituent of the acid or reactive equivalent containing about 6 to about 500 carbon atoms.

In one embodiment, the surfactant (iii)(a) is made by reacting a polyisobutene substituted succinic anhydride having an average of about 1 to about 3 succinic groups for each equivalent of polyisobutene group with an alkanol amine (e.g., dietylethanolamine or dimethylethanolamine) in an equivalent ratio of about 1 to about 0.4-1.25, and in one embodiment about 1:1. The polyisobutene group may have a number average molecular weight of about 750 to about 3000, and in one embodiment about 900 to about 2000.

In one embodiment, the surfactant (iii)(a) comprises a mixture of at least two compounds: one of the compounds being the reaction product of a hydrocarbon-substituted succinic acid or anhydride with ammonia, an amine, an alcohol, or a mixture of two or more thereof, the hydrocarbon substituent of the one compound having about 6 to about 500 carbon atoms; another of the compounds being different than the one compound and being the reaction product of a hydrocarbon-substituted succinic acid or anhydride with ammonia, an amine, an alcohol, or a mixture of two or more thereof, the hydrocarbon substituent of the another compound having about 50 to about 500 carbon atoms.

In one embodiment, the surfactant (iii)(a) comprises a mixture of at least two compounds: one of the compounds being the reaction product of a hydrocarbon-substituted succinic acid or anhydride with an alkanol amine; another of the compounds being the reaction product of a hydrocarbon-substituted succinic acid or anhydride with at least one ethylene polyamine.

In one embodiment, the surfactant (iii)(a) comprises (I) a first polycarboxylic acylating agent having at least one hydrocarbon substituent of about 6 to about 500 carbon atoms, (II) a second polycarboxylic acylating agent optionally having at least one hydrocarbon substituent of up to about 500 carbon atoms, the polycarboxylic acylating agents (I) and (II) being the same or different and being linked together by (III) a linking group derived from a compound having two or more primary amino groups, two or more secondary amino groups, at least one primary amino group and at least one secondary amino group, at least two hydroxyl groups, or at least one primary or secondary amino group and at least one hydroxyl group, the polycarboxylic acylating agents (I) and (II) being reacted with ammonia, an amine, an alcohol, or a mixture of two or more thereof.

In one embodiment, the surfactant (iii)(a) comprises (I) a first polyisobutene substituted succinic acid or anhydride, the first polyisobutene-substituted succinic acid or anhydride having at least one polyisobutene substituent of about 8 to about 500 carbon atoms, (II) a second polyisobutene-substituted succinic acid or anhydride, the second polyisobutene-substituted succinic acid or anhydride having at least one polyisobutene substituent of up to about 500 carbon atoms, the polyisobutene-substituted succinic acids or anhydrides(l) and (II) being the same or different and being linked together by (III) a linking group derived from a compound having two or more primary amino groups, two or more secondary amino groups, at least one primary amino group and at least one secondary amino group, at least two hydroxyl groups, or at least one primary or secondary amino group and at least one hydroxyl group, the polyisobutene-substituted succinic acids or anhydrides (I) and (II) being reacted with an alkanol amine (e.g., dimethylethanol amine or diethylethanol amine).

In one embodiment, the surfactant (iii)(a) comprises a mixture of: the product made from the reaction of a polyisobutene-substituted succinic acid or anhydride with an alkanol amine wherein the polyisobutene group has about 8 to about 500 carbon atoms; the product made from the reaction of a hydrocarbon-substituted succinic acid or anhydride with an alkanol amine wherein the hydrocarbon substituent has about 6 to about 30 carbon atoms; and the product made from the reaction of a polyisobutene-substituted succinic acid or anhydride with at least one alkylene polyamine wherein in the polyisobutene group has about 8 to about 500 carbon atoms.

In one embodiment, the surfactant (iii)(a) comprises a mixture of: the product made from the reaction of a polyisobutene-substituted succinic acid or anhydride with dimethyethanol amine or diethyethanol amine wherein the polyisobutene group has a number average molecular weight of about 1500 to about 3000; the product made from the reaction of a hydrocarbon-substituted succinic acid or anhydride with dimethylethanol amine or diethyethanol amine wherein the hydrocarbon substituent has about 6 to about 30 carbon atoms; and the product made from the reaction of a polyisobutene-substituted succinic acid or anhydride and at least one ethylene polyamine wherein in the polyisobutene group has a number average molecular weight of about 750 to about 1500.

The following examples are provided to illustrate the preparation of the surfactant (iii)(a).

### EXAMPLE (iii)(a)-1

A twelve-liter, four-neck flask is charged with Adibis ADX 101G (7513 grams). Adibis ADX 101G, which is a product available from Lubrizol Adibis, is comprised of a polyisobutene substituted succinic anhydride mixture wherein 60% by weight is a first polyisobutene substituted succinic anhydride wherein the polyisobutene substituent has a number average molecular weight of 2300 and is derived from a polyisobutene having methylvinylidene isomer content of 80% by weight, and 40% by weight is a second polyisobutene-substituted succinic anhydride wherein the polyisobutene substituent has a number average molecular weight of 1000 and is derived from a polyisobutene having methylvinylidene isomer content of 85% by weight. The product has a diluent oil content of 30% by weight and a succination ratio of 1.4 (after correcting for unreacted polyisobutene). The flask is equipped with an overhead stirrer, a thermocouple, an addition funnel topped with an N₂ inlet, and a condenser. The succinic anhydride mixture is stirred and heated at 95° C., and ethylene glycol (137 grams) is added via the addition funnel over five minutes. The resulting mixture is stirred and maintained at 102-107° C. for 4 hours. Dimethylaminoethanol (392 grams) is charged to the mixture over 30 minutes such that the reaction temperature does not exceed 107° C. The mixture is maintained at 100-105° C. for 2 hours, and filtered to provide a brown, viscous product.

### EXAMPLE (iii)(a)-2

A three-liter, four-neck flask is charged with Adibis ADX 101G (1410 grams). The flask is equipped with an overhead stirrer, a thermocouple, an addition funnel topped with an N₂ inlet, and a condenser. The succinic anhydride mixture is stirred and heated to 61° C. Ethylene glycol (26.3 grams) is added via the addition funnel over five minutes. The resulting mixture is stirred and heated to 105-110° C. and maintained at that temperature for 4.5 hours. The mixture is cooled to 96° C., and dimethylaminoethanol (77.1 grams) is charged to the mixture over 5 minutes such that the reaction temperature does not exceed 100° C. The mixture is maintained at 95° C. for one hour, and then at 160° C. for four hours. The product is a brown, viscous product.

### EXAMPLE (iii)(a)-3

A reaction mixture comprising 196 parts by weight of mineral oil, 280 parts by weight of a polyisobutenyl (M.W. 1000)-substituted succinic anhydride (0.5 equivalent) and 15.4 parts of a commercial mixture of ethylene polyamine having an average composition corresponding to that of tetra ethylene pentamine (0.375 equivalent) is mixed over a period of approximately fifteen minutes. The reaction mass is then heated to 150° C. over a five-hour period and subsequently blown with nitrogen at a rate of five parts per hour for five hours while maintaining a temperature of 150° C. to 155° C. to remove water. The material is then filtered producing 477 parts of product in oil solution.

Surfactant (iii)(b)

The surfactant (iii)(b) is comprised (I) a polycarboxylic acylating agent, and (II) a copolymer derived from at least one olefin monomer and at least one alpha, beta unsaturated carboxylic acid or derivative thereof. The acylating agent (I) and copolymer (II) are linked together by (III) a linking group derived from a compound having two or more primary amino groups, two or more secondary amino groups, at least one primary amino group and at least one secondary amino group, at least two hydroxyl groups, or at least one primary or secondary amino group and at least one hydroxyl group.

The polycarboxylic acylating agent (I) is a polycarboxylic acid or reactive equivalent thereof. The polycarboxylic acids include dicarboxylic acids, although tricarboxylic acids and tetracarboxylic acids may be used. The reactive equivalents include acid halides, anhydrides and esters, including partial esters. The polycarboxylic acylating agent may contain at least one hydrocarbon substituent. In one embodiment, the polycarboxylic acylating agent is a hydrocarbon substituted succinic acid or anhydride. The hydrocarbon substituent may contain from 1 to about 500 carbon atoms, and in one embodiment about 6 to about 500 carbon atoms, and in one embodiment about 12 to about 500 carbon atoms, and in one embodiment about 18 to about 500 carbon atoms, and in one embodiment about 24 to about 500 carbon atoms, and in one embodiment about 30 to about 500 carbon atoms, and in one embodiment about 40 to about 500 carbon atoms, and in one embodiment about 50 to about 500 carbon atoms. In one embodiment, the hydrocarbon substituent is a polyisobutene group having a number average molecular weight in the range of about 500 to about 3000, and in one embodiment about 700 to about 2600. These polycarboxylic acylating agents are the same as the polycarboxylic acylating agents described above in the description of the surfactant (iii)(a).

The alpha-beta olefinically unsaturated carboxylic acid used in making the copolymer (II) may be either monobasic or polybasic. Exemplary of the monobasic alpha-beta olefinically unsaturated carboxylic acids include the carboxylic acids corresponding to the formula

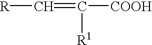

wherein R is hydrogen, or a saturated aliphatic or alicyclic, aryl, alkylaryl or heterocyclic group, and R¹ is hydrogen or a lower alkyl group. R may be a lower alkyl group. The total number of carbon atoms in R and R¹ typically does not exceed about 18 carbon atoms. Specific examples of useful monobasic alpha-beta olefinically unsaturated carboxylic acids include acrylic acid; methacrylic acid; cinnamic acid; crotonic acid; 3-phenyl propenoic acid; alpha, and beta-decenoic acid. The polybasic acids may be dicarboxylic, although tri- and tetracarboxylic acids can be used. Exemplary polybasic acids include maleic acid, fumaric acid, mesaconic acid, itaconic acid and citraconic acid. Reactive equivalents of the alpha-beta olefinically unsaturated carboxylic acids include the anhydride, ester or amide functional derivatives of the foregoing acids. A useful reactive equivalent is maleic anhydride.

The olefin monomers used in making the copolymer (II) may be one or more polymerizable olefin monomers characterized by having one or more ethylenic unsaturated groups. They can be monoolefinic monomers such as ethylene, propylene, butene-1, isobutene and octene-1 or polyolefinic monomers (usually di-olefinic monomers such as butadiene-1,3 and isoprene).

These monomers may be terminal olefins, that is, olefins characterized by the presence of the group>C═CH₂. However, certain internal olefins can also serve as monomers (these are sometimes referred to as medial olefins). The medial olefin monomers may be used in combination with the terminal olefins. The olefin monomers may include aromatic groups (such as phenyl groups and lower alkyl and/or lower alkoxy-substituted phenyl groups (e.g., para(tertiary-butyl)-phenyl groups)) and alicyclic groups such as would be obtained from polymerizable cyclic olefins or alicyclic-substituted polymerizable cyclic olefins.

The olefin monomers may be hydrocarbon olefins of 2 to about 30 carbon atoms, and in one embodiment 2 to about 16 carbon atoms, and in one embodiment 2 to about 6 carbon atoms, and in one embodiment 2 to about 4 carbon atoms.

Specific examples of terminal and medial olefin monomers which can be used include ethylene, propylene, butene-1, butene-2, isobutene, pentene-1, hexene-1, heptene-1, octene-1, nonene-1, decene-1, dodecent-1, tridecene-1, tetradecene-1, pentadecene- 1, hexadecene-1, heptadecene-1, octadecene-1, eicosene-1, docosene-1, triacontene-1, pentene-2, propylene tetramer, diisobutylene, isobutylene trimer, butadiene-1,2, butadiene-1,3, pentadiene-1,2, pentadiene-1,3, isoprene, hexadiene-1,5, 2-chlorobutadiene-1,3, 2-methylheptene-1,3-cyclohexylbutene-1,3,3-dimethylpentene-1, styrenedivinylbenzene, vinyl-acetate allyl alcohol, 1-methylvinylacetate, acrylonitrile, ethyl acrylate, ethylvinylether and methyl-vinylketone. These include the following alpha olefin fractions: C₁₅₋₁₈ alpha-olefins, C₁₂₋₁₆ alpha-olefins, C₁₄₋₁₆ alpha-olefins, C₁₄₋₁₈ alpha-olefins, C₁₆₋₁₈ alpha-olefins, C₁₈₋₂₄ alpha-olefins, C₁₈₋₃₀ alpha-olefins, and the like.

In one embodiment, the copolymer (II) is a copolymer of styrene and maleic anhydride. In one embodiment it is a copolymer of octadecene-1 and maleic anhydride.

The copolymer (II) may be prepared by reacting the olefin monomer with the alpha, beta olefinically unsaturated carboxylic or derivative in the presence of a dialkyl peroxide (e.g., di-t-butyl peroxide) initiator. This is disclosed in British Patent 1,121,464 which is incorporated herein by reference. The molar ratio of olefin monomer to alpha, beta unsaturated carboxylic acid or derivative may range from about 2:1 to about 1:2, and in one embodiment it is about 1:1. The copolymer (II) may have a number average molecular weight in the range of about 2000 to about 50,000, and in one embodiment about 5000 to about 30,000, and in one embodiment about 6000 to about 12,000.

The linking group (III) for linking the acylating agent (I) with the copolymer (II) may be derived from a polyol, a polyamine, a hydroxyamine or a mixture of two or more thereof. These are the same as linking compounds (III) described above in the description of the surfactant (iii)(a) for linking the acylating agent (I) with the acylating agent (II).

The acylating agent (I) and copolymer (II) may be reacted with the linking compound (III) according to conventional ester and/or amide-forming techniques. Alternatively, the linking compound (III) may be reacted with either the acylating agent (I) or copolymer (II) to form an intermediate compound, and then the intermediate compound is reacted with the remaining non-reacted acylating agent (I) or copolymer (II). These reactions involve heating the reactants, optionally in the presence of a normally liquid, substantially inert, organic liquid solvent/diluent. Temperatures of at least about 30° C. up to the decomposition temperature of the reaction component and/or product having the lowest such temperature may be used. The temperature may be in the range of about 50° C. to about 260° C., and in one embodiment about 180° C. to about 225° C.

The ratio of reactants may be varied over a wide range. Generally, for each equivalent of each of the acylating agent (I) and copolymer (II), at least about one equivalent of the linking compound (III) is used. The upper limit of linking compound (III) is about 2 equivalents of linking compound (III) for each equivalent of acylating agent (I) and copolymer (II). Generally the ratio of equivalents of acylating agent (I) to copolymer (II) is about 0.5 to about 2, with about 1:1 being useful.

The number of equivalents of the acylating agent (I) and copolymer (II) depends on the total number of carboxylic functions present in each. In determining the number of equivalents for the acylating agent (I) and copolymer (II), those carboxyl functions which are not capable of reacting with the linking compound (ill) are excluded. In general, however, there is one equivalent of each acylating agent (I) and copolymer (II) for each carboxy group in the acylating agent (I) and copolymer (II). The number of equivalents for the linking compound (III) is determined in the same manner as for the linking compounds used to make the surfactant (iii)(a).

The following example is provided to further disclose the preparation of the surfactant (iii)(b).

### EXAMPLE (iii)(b)-1

To a 5-litre flask equipped with heating mantle, overhead stirrer, pressure equalizing dropping funnel, nitrogen gas inlet, thermocouple and temperature control apparatus open to atmosphere is added an oil solution of polyisobutene (Mn=1600) substituted succinic anhydride (3478 g, 2.0 Eq, 30 wt % 100N diluent oil), poly[1-octadecene-alt-maleic anhydride] (312 g, 1 Eq, Mn=15,000) and 100N diluent oil (139 g). The flask is purged with nitrogen and the temperature is raised to 180° C. with stirring. A light flow of nitrogen is maintained during the course of reaction to aid removal of water. Triethylenetetra amine (176 g, 1.4 Eq) is added dropwise over 3 hours. Once the amine addition is complete, the reaction mixture is stirred for about 4 more hours at 180° C. The reaction mixture is cooled and decanted into a container to provide the desired product.

Surfactant (iii)(c)

The surfactant (iii)(c) is an aromatic Mannich compound derived from a hydroxy aromatic compound, an aldehyde or a ketone, and an amine containing at least one primary or secondary amino group. The hydroxy aromatic compound may be represented by the formula

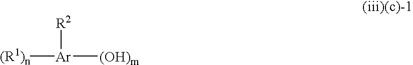

wherein in Formula (iii)(c)-1: Ar is an aromatic group; m is 1, 2 or 3; n is a number from 1 to about 4; with the proviso that the sum of m and n does not exceed the number of available positions on Ar that can be substituted; each R¹ independently is a hydrocarbon group of up to about 400 carbon atoms; and R² is H, amino or carboxy.

In Formula (iii)(c)-1, Ar may be a benzene or a naphthalene nucleus. Ar may be a coupled aromatic compound, the coupling agent preferably being O, S, CH₂, a lower alkylene group having from 1 to about 6 carbon atoms, NH, and the like, with R¹ and OH generally being pendant from each aromatic nucleus. Examples of specific coupled aromatic compounds include diphenylamine, diphenylmethylene and the like. m is usually from 1 to 3, and in one embodiment 1 or 2, and in one embodiment 1. n is usually from 1 to 4, and in one embodiment 1 or 2, and in one embodiment 1. R² may be H, amino or carboxyl, and in one embodiment R² is H. R¹ may be a hydrocarbon group of up to about 400 carbon atoms, and in one embodiment up to about 250 carbon atoms, and in one embodiment up to about 150 carbon atoms. R¹ may be an alkyl group, alkenyl group or cycloalkyl group.

In one embodiment, R¹ is a hydrocarbon group derived from an olefin polymer. The olefin polymer may be derived from an olefin monomer of 2 to about 10 carbon atoms, and in one embodiment about 3 to about 6 carbon atoms, and in one embodiment about 4 carbon atoms. Examples of the monomers include ethylene; propylene; butene-1; butene-2; isobutene; pentene-1; heptene-1; octene-1; nonene-1; decene-1; pentene-2; or a mixture of two or more thereof.

In one embodiment, R¹ is a polyisobutene group. The polyisobutene group may be made by the polymerization of a C₄ refinery stream having a butene content of about 35 to about 75% by weight and an isobutene content of about 30 to about 60% by weight.

In one embodiment, R¹ is a polyisobutene group derived from a polyisobutene having a high methylvinylidene isomer content, that is, at least about 70% methylvinylidene. Suitable high methylvinylidene polyisobutenes include those prepared using boron trifluoride catalysts. The preparation of such polyisobutenes in which the methylvinylidene isomer comprises a high percentage of the total olefin composition is described in U.S. Pat. Nos. 4,152,499 and 4,605,808, the disclosures of each of which are incorporated herein by reference.

Examples of suitable polyisobutenes having a high methylvinylidene content include: Ultravis 10, a polyisobutene having a number average molecular weight of about 950 and a methylvinyidiene content of about 82%; and Ultravis 30, a polyisobutene having a number average molecular weight of about 1300 and a methylvinylidene content of about 74%, both available from BP Amoco.

The polyisobutene may have a number average molecular weight in the range of about 200 to about 5000, and in one embodiment in the range of about 250 to about 3000, and in one embodiment the range of about 300 to about 2500, and in one embodiment in the range of about 500 to about 2300, and in one embodiment about 750 to about 1500.

In one embodiment, the hydroxy aromatic compound is a polyisobutene-substituted phenol wherein the polyisobutene substituent is derived from a polyisobutene having a number average molecular weight in the range of about 300 to about 5000, and in one embodiment about 500 to about 2500, and a methylvinylidene isomer content of at least about 70%, and in one embodiment at least about 80%.

The aldehyde or ketone may be represented by the formula

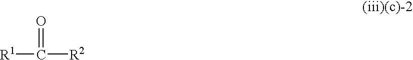

or a precursor thereof; wherein in Formula (iii)(c)-2: R¹ and R² independently are H or hydrocarbon groups having from 1 to about 18 carbon atoms. R¹ and R² may be hydrocarbon groups containing 1 to about 6 carbon atoms, and in one embodiment 1 or 2 carbon atoms. In one embodiment, R¹ and R² may be independently phenyl or alkyl-substituted phenyl groups having up to about 18 carbon atoms, and in one embodiment up to about 12 carbon atoms. R² can also be a carbonyl-containing hydrocarbon group of 1 to about 18 carbon atoms, and in one embodiment 1 to about 6 carbon atoms. Examples of suitable aldehydes and ketones include formaldehyde, acetaldehyde, propionaldehyde, butyraldehyde, valeraldehyde, benzaldehyde, and the like, as well as acetone, methyl ethyl ketone, ethyl propyl ketone, butyl methyl ketone, glyoxal, glyoxylic acid, and the like. Precursors of such compounds which react as aldehydes under reaction conditions of the present invention can also be utilized and include paraformaldehyde, formalin, trioxane and the like. Paraformaldehyde and aqueous solutions of formalin (e.g., about 35% to about 45% by weight formalin in water) may be used. Mixtures of the various aldehydes and/or ketones may be used.

The amine may be any of the amines discussed above having at least one >N—H or —NH₂ group. The remaining valences on the nitrogen atom may be satisfied by hydrogen, amino, or organic groups bonded to the nitrogen atom through direct carbon-to-nitrogen linkages. The amine may be a monoamine, a polyamine or a hydroxyamine.

The ratio of equivalents of hydroxy aromatic compound to aldehyde or ketone to amine may be about 1:(1 to 2):(0.5 to 2). In one embodiment the ratio is about 1:1:1.

Surfactant (iii)(d)

The surfactant (iii)(d) is at least one ionic or nonionic compound having a hydrophilic lipophilic balance (HLB) in the range of about 1 to about 40, and in one embodiment about 1 to about 30, and in one embodiment about 1 to about 20, and in one embodiment about 1 to about 10, and in one embodiment about 4 to about 8. In one embodiment, the HLB is in the range of about 7 to about 30, and in one embodiment about 7 to about 20, and in one embodiment about 7 to about 15. Examples of these compounds are disclosed in McCutcheon's Surfactants and Detergents, 1998, North American & International Edition. Pages 1-235 of the North American Edition and pages 1-199 of the International Edition are incorporated herein by reference for their disclosure of such ionic and nonionic compounds. Useful compounds include alkanolamides, alkylarylsulfonates, amine oxides, poly(oxyalkylene) compounds, including block copolymers comprising alkylene oxide repeat units, carboxylated alcohol ethoxylates, ethoxylated alcohols, ethoxylated alkyl phenols, ethoxylated amines and amides, ethoxylated fatty acids, ethoxylated fatty esters and oils, fatty esters, fatty acid amides, glycerol esters, glycol esters, sorbitan esters, imidazoline derivatives, lecithin and derivatives, lignin and derivatives, monoglycerides and derivatives, olefin sulfonates, phosphate esters and derivatives, propoxylated and ethoxylated fatty acids or alcohols or alkyl phenols, sorbitan derivatives, sucrose esters and derivatives, sulfates or alcohols or ethoxylated alcohols or fatty esters, sulfonates of dodecyl and tridecyl benzenes or condensed naphthalenes or petroleum, sulfosuccinates and derivatives, and tridecyl and dodecyl benzene sulfonic acids.

In one embodiment, the surfactant (iii)(d) is a poly(oxyalkene) compound. These include copolymers of ethylene oxide and propylene oxide. In one embodiment, the ionic or nonionic compound (ii) is a copolymer represented by the formula

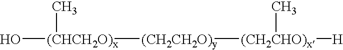

wherein x and x′ are the number of repeat units of propylene oxide and y is the number of repeat units of ethylene oxide, as shown in the formula. In one embodiment, x and x′ are independently numbers in the range of zero to about 20, and y is a number in the range of about 4 to about 60. In one embodiment, this copolymer has a number average molecular weight of about 1800 to about 3000, and in one embodiment about 2100 to about 2700.

In one embodiment, the surfactant (iii)(d) is an ethoxylated alkyl phenol or an alkoxy polyethoxy alcohol. The alkyl group of the ethoxylated alkyl phenol and the alkoxy group of the alkoxy polyethoxy alcohol may contain about 6 to about 30 carbon atoms, and in one embodiment about 6 to about 18 carbon atoms, and in one embodiment about 6 to about 12 carbon atoms. In one embodiment, the alkyl group of the ethoxylated alkyl phenol is octyl or nonyl. The amount of ethoxylation may range from about 1 to about 25 ethylene oxide (EO) units per alkyl chain in the ethoxylated alkyl phenol or per alkoxy group in the alkoxy polyethoxy alcohol. The number of EO units will vary depending on whether the desired emulsion is an oil-in-water emulsion or a water-in-oil emulsion. Typically, the number of EO groups will be greater when an oil-in-water emulsion is desired.

In one embodiment, the surfactant (iii)(d) is an alkyl alcohol, amine, amide or acid ester. The alkyl group may contain from 1 to about 18 carbon atoms, and in one embodiment about 1 to about 8 carbon atoms. In this embodiment the surfactant (iii)(d) tends to enhance the formation of micro-emulsions. Typical examples for this use include methanol, ethanol, pentanol, hexanol and ethylhexyl alcohol. These surfactants may be utilized in conjunction with other surfactants such as ethoxylated alkyl phenols or amine salts of carboxylic acids discussed above.

The HLB of the surfactant (iii)(d) is often a primary determinant of the nature of the final emulsion. Water-in-oil emulsions tend to require lower HLB values, e.g., less than about 6, whereas oil-in-water emulsions tend to require higher HLB values, e.g., greater than about 6. These values may be modified based on the ratio of oil to water. Higher values of this ratio, e.g., ratios greater than about 1:1 by volume, tend to form water-in-oil emulsions, while lower values of this ratio, e.g., ratios less than about 1:1 by volume, tend to form oil-in-water emulsions.

Organic Solvent

The surfactants (iii)(a) to (iii)(d) may be diluted with a substantially inert, normally liquid organic solvent such as mineral oil, synthetic oil (e.g., ester of dicarboxylic acid), naphtha, alkylated (e.g., C₁₀-C₁₃ alkyl) benzene, toluene, xylene or a normally liquid hydrocarbon fuel to form an additive concentrate which is then mixed with the hydrocarbon feedstock and water during step (A) of the inventive process. These concentrates generally contain from about 10% to about 90% by weight of the foregoing solvent. The water blended hydrocarbon feedstock composition formed during step (A) may contain up to about 10% by weight organic solvent, and in one embodiment about 0.01 to about 5% by weight, and in one embodiment about 0.01 to about 1% by weight.

The Water-Soluble Salt (iv)

The water blended hydrocarbon feedstock composition formed during step (A) may include (iv) at least one water-soluble salt. The water-soluble salt may be an organic amine nitrate, azide or nitro compound. The water-soluble salt may be an alkali or alkaline earth metal carbonate, sulfate, sulfide, sulfonate or nitrate. Mixtures of two or more of the foregoing may be used.

The water soluble salt may be an amine or ammonium salt represented by the formula

k[G(NR₃)_{y}]^{y+}nX^{p-}

wherein G is hydrogen or an organic group of 1 to about 8 carbon atoms, and in one embodiment 1 to about 2 carbon atoms, having a valence of y; each R independently is hydrogen or a hydrocarbon group of 1 to about 10 carbon atoms, and in one embodiment 1 to about 5 carbon atoms, and in one embodiment 1 to about 2 carbon atoms; X^{p-} is an anion having a valence of p; and k, y, n and p are independently integers of at least 1. When G is H, y is 1. The sum of the positive charge ky⁺ is equal to the sum of the negative charge nX^{p-}. In one embodiment, X is a nitrate ion; and in one embodiment it is an acetate ion. Examples include ammonium nitrate, methylammonium nitrate, urea nitrate, and urea dintrate. Ammonium nitrate is useful.

In one embodiment, the water-soluble salt stabilizes the water blended hydrocarbon feedstock composition formed during step (A). The water-soluble salt (iv) may be present in the water blended hydrocarbon feedstock composition formed during step (A) at a concentration of about 0.001 to about 25% by weight, and in one embodiment about 0.01 to about 15% by weight, and in one embodiment about 0.01 to about 10% by weight, and in one embodiment about 0.01 to about 5% by weight, and in one embodiment about 0.01 to about 2% by weight, and in one embodiment from about 0.01 to about 1% by weight.

In one embodiment, the water-soluble salt enhances the oxidation of the water blended hydrocarbon feedstock composition formed during step (A) when the composition is oxidized during the partial oxidation step that may be used with the inventive process. In this embodiment the water-soluble salt is typically an amine or ammonium nitrate. The concentration of the water soluble salt is present in the water blended hydrocarbon feedstock formed during step (A) in an oxidation enhancing amount. The concentration may be in the range of about 0.01 to about 15% by weight, and in one embodiment about 0.01 to about 10% by weight, and in one embodiment about 0.01 to about 5% by weight, and in one embodiment about 0.01 to about 2% by weight, and in one embodiment about 0.01 to about 1% by weight.

Antifreeze Agent

In one embodiment, the water blended hydrocarbon feedstock composition formed during step (A) contains an antifreeze agent. The antifreeze agent may be an alcohol. Examples include ethylene glycol, propylene glycol, methanol, ethanol, and mixtures thereof. The antifreeze agent is typically used at a concentration sufficient to prevent freezing of the water used in the water blended hydrocarbon feedstock composition formed during step (A). The concentration is therefore dependent upon the temperature at which the process is operated or the temperature at which the water blended hydrocarbon feedstock composition is stored or used. In one embodiment, the concentration is at a level of up to about 10% by weight, and in one embodiment about 0.1 to about 10% by weight of the water blended hydrocarbon feedstock composition formed during step (A), and in one embodiment about 1 to about 5% by weight.

Forming the Water Blended Hydrocarbon Feedstock

The hydrocarbon feedstock, water, surfactant and optionally other ingredients as discussed above may be mixed under appropriate mixing conditions to form the desired water blended hydrocarbon feedstock composition. Either low shear mixing or high shear mixing may be used to form water-in-oil or oil-in-water emulsions. For micro-emulsions very low or minimal shear mixing conditions may be used. Emulsions with dispersed phases having relatively large mean droplet sizes (e.g., about 50 microns) may be made using low shear mixing. Emulsions with dispersed phases having relatively small mean droplet sizes (e.g., about 1 micron) may be made using high shear mixing. The mixing may be conducted at a temperature in the range of about 0 to about 100° C., and in one embodiment about 10 to about 50° C., and in one embodiment about 15 to about 40° C.

### Step (B)

Step (B) of the inventive process involves steam reforming the water blended hydrocarbon feedstock composition formed during step (A) to form a product comprising hydrogen and one or more carbon oxides (i.e., CO, CO₂). This steam reforming step may be conducted in the presence of a steam reforming catalyst. During step (B) the water blended hydrocarbon feedstock formed in step (A) is mixed with steam, and the resulting mixture is vaporized. Vaporization may be effected using known procedures. For example, the water blended hydrocarbon feedstock composition may be mixed with the steam in a vaporizer.

The steam may have a temperature of about 50 to about 1100° C., and in one embodiment about 100 to about 1000° C., and in one embodiment about 200 to about 700° C., and in one embodiment about 300 to about 450° C. The steam pressure may be in the range of about 1 to about 5000 psig (about 6.895 to about 34,475 kPa gage pressure), and in one embodiment about 1 to about 2000 psig (about 6.895 to about 13,790 kPa), and in one embodiment about 1 to about 1000 psig (about 6.895 to about 6895 kPa), and in one embodiment about 1 to about 500 psig (about 6.895 to about 3447.5 kPa), and in one embodiment about 1 to about 100 psig (about 6.895 to about 689.5 kPa).

The vaporized mixture of water blended hydrocarbon feedstock and steam may have a temperature in the range of about 50 to about 1200° C., and in one embodiment about 100 to about 1200° C., and in one embodiment about 300 to about 1200° C., and in one embodiment about 500 to about 1200° C., and in one embodiment about 700 to about 1200° C., and in one embodiment about 800 to about 1200° C., and in one embodiment about 800 to about 1100° C. The vaporized mixture may have a pressure of about 1 to about 5000 psig (about 6.895 to about 34,475 kPa gage pressure), and in one embodiment about 1 to about 2000 psig (about 6.895 to about 13,790 kPa), and in one embodiment about 1 to about 1000 psig (about 6.895 to about 6895 kPa), and in one embodiment about 1 to about 500 psig (about 6.895 to about 3447.5 kPa), and in one embodiment about 1 to about 100 psig (about 6.895 to about 689.5 kPa).

The water to carbon mole ratio of the vaporized mixture of water blended hydrocarbon feedstock and steam may range from about 1:2 to about 20:1, and in one embodiment about 2:1 to about 10:1. The oxygen to carbon mole ratio may range from about 0:1 to about 1:1, and in one embodiment about 0.1:1 to about 1:1, and in one embodiment about 0.2:1 to about 0.4:1.

The vaporized mixture of water blended hydrocarbon feedstock composition and steam may contact the steam reforming catalyst for an effective period of time to react the hydrocarbons therein with water to produce the hydrogen and carbon oxides. The contacting time may range from about 0.05 second to about 1 hour, and in one embodiment about 0.05 second to about 30 minutes, and in one embodiment about 0.05 second to about 10 minutes, and in one embodiment about 0.05 second to about 1 minute, and in one embodiment about 0.05 second to about 30 seconds, and in one embodiment about 0.05 second to about 10 seconds, and in one embodiment about 0.2 second to about 5 seconds.

The steam reforming catalyst may utilize a monolithic carrier, that is, a carrier of the type comprising one or more monolithic bodies having a plurality of finely divided gas flow passages extending therethrough. Such monolithic carrier members are often referred to as “honeycomb” type carriers and are well known in the art. The steam reforming catalyst may utilize a particulate support such as spheres, extrudates, granules, shaped members (such as rings or saddles) or the like. A useful support is alumina pellets or extrudate having a BET (Brunnauer-Emmett-Teller) surface area of from about 10 to about 200 square meters per gram. Alumina or alumina stabilized with rare earth metal and/or alkaline earth metal oxides may be utilized as the pellets or extrudate. An alumina particulate support stabilized with lanthanum and barium oxides may be used.

The catalytically active metals for the steam reforming catalyst may comprise any of the catalytic metals known for such purpose, for example, nickel, cobalt and mixtures thereof. Platinum group metals such as platinum and rhodium or both may also be utilized for steam reforming. The term “platinum group metals” refers to platinum, palladium, rhodium, iridium, osmium and ruthenium. A useful platinum group metal steam reforming catalyst is comprised of platinum and rhodium with the rhodium comprising from about 10 to 90% by weight, and in one embodiment about 30% by weight, of the total platinum group metal present. Other platinum group metals may be utilized. For example, one or more of palladium, iridium, osmium or ruthenium may be utilized in the steam reforming catalyst.

In one embodiment, prior to commencing steam reforming, the water blended hydrocarbon feedstock composition formed in step (A) is partially oxidized to increase the temperature of the water blended hydrocarbon feedstock composition to a level sufficient for steam reforming. This may be done in the presence of an oxidation catalyst. This involves oxidizing from about 0.01 to about 90% by weight, and in one embodiment about 0.1 to about 50% by weight, and in one embodiment about 1 to about 30% by weight, of the water blended hydrocarbon feedstock composition to produce an effluent gas and the heat required for the endothermic steam reforming reaction that is conducted during step (B) of the inventive process. The temperature of the water blended hydrocarbon feedstock composition may be increased to a level in the range of about 425° C. to about 1370° C., and in one embodiment about 800° C. to about 1200° C. using this partial oxidation step. At these temperatures a degree of hydrocracking of unoxidized C₅ and heavier hydrocarbons in the hydrocarbon feedstock may take place resulting in the formation of C₄ and lighter compounds. The effluent gas from this partial oxidation step typically contains primarily CO, CO₂ and H₂, and may also contain one or more of H₂O, N₂, C₂ to C₄ hydrocarbons, and other lighter hydrocarbons, including olefins, and, depending upon the sulfur content of the hydrocarbon feedstock, H₂S and COS. This effluent gas is then subjected to steam reforming pursuant to step (B) of the inventive process.

The oxidation catalyst may be provided on a monolithic carrier. A useful carrier is made of a refractory, substantially inert rigid material which is capable of maintaining its shape and a sufficient degree of mechanical strength at high temperatures, for example, up to about 1800° C. Typically, a material is selected for the support which exhibits a low thermal coefficient of expansion, good thermal shock resistance and, though not always, low thermal conductivity. Examples include alumina, alumina-silica, alumina-silica-titania, mullite, cordierite, zirconia, zirconia-spinel, zirconia-mullite, silicon carbide, etc. The gas flow passages are typically sized to provide from about 50 to about 1200 gas flow channels per square inch (about 7.75 to about 186 channels per square centimeter), and in one embodiment about 200 to about 600 gas flow channels per square inch (about 31 to about 93 channels per square centimeter) of face area.

The oxidation catalyst may use as a carrier a heat- and oxidation-resistant metal, such as stainless steel or the like. Monolithic supports are typically made from such materials by placing a flat and a corrugated metal sheet one over the other and rolling the stacked sheets into a tubular configuration about an axis parallel to the corrugations, to provide a cylindrical-shaped body having a plurality of fine, parallel gas flow passages extending therethrough. The sheets and corrugations are sized to provide the desired number of gas flow passages, which may range, typically, from about 200 to about 1200 per square inch (about 31 to about 186 per square centimeter) of end face area of the tubular roll.

Although the ceramic-like metal oxide materials such as cordierite or alumina-silica-titania are somewhat porous and rough-textured, they nonetheless have a relatively low surface area with respect to catalyst support requirements, and stainless steel and other metal supports are essentially smooth. Accordingly, a suitable high surface area refractory metal oxide support layer may be deposited on the carrier to serve as a support upon which finely dispersed catalytic metal may be distended. As is known in the art, generally, oxides of one or more of the metals of Groups II, III, and IV of the Periodic Table of Elements having atomic numbers not greater than 40 are satisfactory as the support layer. Useful surface area support coatings include alumina, beryllia, zirconia, baria-alumina, magnesia, silica, and combinations of two or more thereof.

In one embodiment, the support coating is a stabilized, high-surface area transition alumina. The term “transition alumina” includes gamma, chi, eta, kappa, theta and delta forms and mixtures thereof. Additives such as one or more rare earth metal oxides and/or alkaline earth metal oxides may be included in transition alumina (usually in amounts comprising from about 2 to about 10% by weight of the coating) to stabilize the coating against the generally undesirable high temperature phase transition to alpha alumina, which has a relatively low surface area. For example, oxides of one or more of lanthanum, cerium, praseodymium, calcium, barium, strontium and magnesium may be used as a stabilizer.

The platinum group metal catalytic component of the oxidation catalyst may comprise palladium and platinum and, optionally, one or more other platinum group metals. Useful platinum group metal components include palladium and platinum and, optionally, rhodium. The platinum group metal may optionally be supplemented with one or more base metals, particularly base metals of Group VII and metals of Groups VB, VIB and VIB of the Periodic Table of Elements. These include chromium, copper, vanadium, cobalt, nickel, and mixtures of two or more thereof.

Steam reforming catalysts and oxidation catalysts that may be used with the inventive process are disclosed in U.S. Pat. No. 4,522,894, which is incorporated herein by reference.

The inventive process, in at least one embodiment, provides for one or more of the following advantages:

Lower hydrogen cost due to improved efficiency of the process.

Lower capitals cost, or increase in throughput for an existing steam reforming unit, due to lower water requirements.

Lower hydrodesulfurizaiton requirement for the hydrocarbon feedstock.

Higher conversion to hydrogen.

Higher conversion of CO.

Lower level of water required for a given purity of hydrogen, leading to higher throughput and lower energy demand.

Higher purity product for a given level of water.

Lower CO and S impurities for a given condition (level of water and of hydrodesulfurization).

More efficient operation and longer equipment life for fuel cell applications, such as those based on proton exchange membranes.

An advantage of the inventive process is that heavier hydrocarbon feedstocks can be handled and transported more readily because of their being blended with water.

The hydrogen produced by the inventive process may be used in one or more of the following:

1. Refinery Operations—Steam reforming a water blended hydrocarbon feedstock composition wherein the hydrocarbon feedstock is a refinery product or stream (e.g., naphtha) to produce hydrogen for refinery hydrogen applications, such as:

hydrocracking

hydrorefining

hydrotreating

hydrodesulfurization

2. Chemical Processes—Steam reforming a water blended hydrocarbon feedstock composition wherein the hydrocarbon feedstock is, for example, diesel fuel, to produce hydrogen for chemical processes, including:

Ammonia synthesis from N₂ (by Haber-Bosch process).

Aromatic hydrogenation.

Hydroforming olefinic hydrocarbons to convert the olefinic hydrocarbons to branched-chain paraffins.

Preparation of alcohols from synthesis gas.

Hydrogenation of fats and oils

3. Fuel Cells—Steam reforming a water blended hydrocarbon feedstock composition to produce hydrogen as feed for fuel cells such as proton exchange membrane cells.

### EXAMPLES 1-3, C-1 AND C-2

The following Examples 1-3 are provided to further disclose the inventive process. In Examples 1-3 water-in-oil emulsions within the scope of the invention using certain diesel fuels as the hydrocarbon feedstock are steam reformed. Examples C-1 and C-2 are not within the scope of the invention, but are provided for purposes of comparison. In Examples C-1 and C-2 the diesel fuels used in Examples 1-3 are steam reformed without being emulsified.

Step (A)

The following chemical additive mixture is used. This additive mixture contains surfactants corresponding to surfactant (iii)(a) and a water-soluble salt corresponding to water-soluble salt (iv).

| Ingredient | Wt. % |
|---|---|
| Ester/salt prepared by reacting polyisobutene (Mn = 2000) | 40.0 |
| substituted succinic anhydride (ratio of succinic groups to | |
| polyisobutene equivalent weights = 1.7) with dimethylethanol | |
| amine at a molar ratio of 1:2. | |
| Succinimide derived from polyisobutene (Mn = 1000) | 19.8 |
| substituted succinic anhydride and ethylene | |
| polyamine mixture containing 15-25 weight percent | |
| diethylene triamine with the remainder being heavy | |
| polyamines having seven or more nitrogen atoms per | |
| molecule and two or more primary amines per molecule. | |
| Ester/salt made by reacting hexadecenyl succinic anhydride | 7.1 |
| with dimethylethanol amine at a molar ratio of 1:1.35. | |
| 2-ethylhexyl nitrate. | 23.8 |
| Ammonium nitrate solution (54% by wt. NH₄NO₃ in water). | 9.3 |

The following hydrocarbon feedstocks are used: a medium sulfur (0.47 wt. % S) NATO F-76 marine diesel fuel having a density of 0.842 gm/cc (MSD); and a high sulfur (0.80 wt. % S) NATO F-76 marine diesel fuel having a density of 0.842 gm/cc (HSD).

The composition used in each of Examples 1-3 is in the form of water-in-oil emulsion. The emulsion has the following formulation:

| | Wt. % |
|---|---|
| NATO F-76 marine diesel fuel | 77.0 |
| (MSD or HSD) | |
| Chemical additive mixture | 3.0 |
| Deionized water | 20.0 |

The water-in-oil emulsions used in Examples 1-3 are prepared using the following mixing procedure:

(1) The diesel fuel (MSD or HSD) is added to a mixing tank.

(2) The chemical additive mixture is mixed and then added to the diesel fuel.

(3) The mixture of diesel fuel and chemical additives is mixed in the mixing tank for 10-15 minutes.

(4) A DR3-9P IKA high shear mixer is set to a flow rate of 25 gallons (94.75 liters) per minute with the mixture of diesel fuel and chemical additives being mixed in the mixer.

(5) Deionized water is blended with the mixture of diesel fuel and chemical additives by adding the deionized water to the high shear mixer on the suction side at a rate of one gallon per minute using an induction tube. Once the water addition is complete, the mixture of diesel fuel, chemical additives and deionized water is recycled through the high shear mixer 10 times to complete the preparation of the desired water-in-oil emulsion.

The water-in-oil emulsion used in Examples 1-3 is characterized by a continuous oil (or diesel fuel) phase, and a discontinuous aqueous phase. The discontinuous aqueous phase is comprised of aqueous droplets having a mean diameter of 0.6-0.8 micron.

Step (B)

An autothermal reformer is used to convert the hydrocarbons in the water-in-oil emulsion formed in step (A) (Examples 1-3) or the corresponding diesel fuels (Examples C-1 and C-2) to products comprising hydrogen gas and carbon oxides. The autothermal reformer has two tubes in an annular arrangement located inside an insulated pressure vessel. An upper portion of the inner tube holds two catalyst beds. The lower portion is filled with packing to provide heat exchange with incoming emulsion (or diesel fuel)/steam mixture. A mixture of the emulsion formed in step (A) (or diesel fuel) and steam is vaporized and enters the bottom of the autothermal reformer at a temperature of at about 500° F. (260° C.) and is preheated to about 1400° F. (760° C.). The preheated emulsion (or diesel fuel)/steam vapor mixture is combined with preheated air, which is at a temperature of 1000° F. (537.8° C.), and enters the top of the first catalyst bed through injection nozzles.

The two catalyst beds are arranged in series. The catalyst in the first catalyst bed is a combustion catalyst and the catalyst in the second catalyst bed is a steam reforming catalyst. The first catalyst bed is designed to exhibit levels of combustion and reforming activities that do not yield a sharp rise in temperature. The reaction rates are sufficient to oxidize a portion of the emulsion (or diesel fuel) so that a gradual distribution of heat occurs in the direction of flow. The second catalyst bed is more reactive for steam reforming. The catalyst beds weigh a total of 21.9 pounds (9.95 kg) and have an approximate volume of 0.434 ft³ (12.3 liters). Each of the catalysts is comprised of a lanthia-chromia-alumina frit impregnated with platinum group metals. The frit has the following composition:

| Component | Wt. % |
|---|---|
| La₂O₃ | 3.8 |
| Cr₂O₃ | 1.8 |
| Al₂O₃ | 94.4 |

The lanthia-chromia stabilized alumina is impregnated with the platinum group metals identified below and calcined in air for four hours at 230° F. (110° C.) and then for an additional four hours at 1600° F. (871° C.). The catalysts have the following platinum group metal loadings:

Weight Percent

| | Pd | Pt | Rh |
|---|---|---|---|
| First Catalyst | 3.42 | 5.95 | — |
| Second Catalyst | — | 5.62 | 3.14 |

The operating temperature for the autothermal reformer ranges from 1800° F. (982° C.) to 2000° F. (1093° C.) for the first catalyst bed and 1600° F. (871° C.) to 1800° F. (982° C.) for the second catalyst bed.

The vaporizer uses superheated steam at 70 psia (482.65 kPa) and 900° F. (482° C.) to provide the heat to vaporize the emulsion (or diesel fuel) and to provide an emulsion (or diesel fuel)/steam mixture having a temperature of 500° F. (260° C.). Since a significant portion (20%) of the emulsion is liquid water, the steam flow is reduced in Examples 1-3 to maintain a constant water-to-carbon feed ratio to the autothermal reactor.

Three steady state tests are performed with the emulsions from step (A) (Examples 1-3) and two comparative examples with the corresponding diesel fuels before (Example C-1) and after (Example C-2) the test runs with the emulsions. Examples C-1 and 1 are conducted using the medium sulfur fuel (MSD) while Examples 2, 3 amd C-2 are conducted using the high-sulfur diesel fuel (HSD). The operating conditions and test results are summarized in Tables 1-3.

TABLE 1
Autothermal Reactor Operating Conditions

| Ex. | Duration | S/C* | O₂/C** | Flow*** | Steam + | Fuel +**** | Air | Reactor Outlet |
|---|---|---|---|---|---|---|---|---|
| No. | hrs | Ratio | Ratio | kg/h | Feed ° C. | Steam ° C. | Inlet ° C. | Pressure kPa |
| C-1 | 3 | 3.51 | 0.343 | 5.36 | 377 | 282 | 616 | 208.2 |
| 1 | 12 | 3.48 | 0.343 | 6.72 | 471 | 262 | 610 | 209.6 |
| 2 | 9 | 3.50 | 0.342 | 6.72 | 417 | 271 | 616 | 210.3 |
| 3 | 8 | 3.35 | 0.366 | 7.14 | 454 | 249 | 577 | 373.7 |
| C-2 | 5 | 3.20 | 0.365 | 5.73 | 366 | 263 | 556 | 371.0 |

*S/C is the steam-to-carbon molar ratio. It is the ratio of the moles of water in the fuel feed plus the steam feed divided by the moles of carbon in the fuel feed.
**O₂/C is the oxygen-to-carbon molar ratio. It is the ratio of moles of oxygen in the air feed divided by the moles of carbon in the fuel feed.
***Flow rate of emulsion for Examples 1-3, and flow rate of diesel fuel for Examples C-1 and C-2.
****Temperature of the mixture of emulsion and steam for Examples 1-3, and diesel fuel and steam for Examples C-1 and C-2.

TABLE 2
Autothermal Reactor Test Results

| | | | | | Cold | Catalyst Bed |
|---|---|---|---|---|---|---|
| | | | | Carbon | Gas** | Pressure |
| Ex. | Bed Temperatures, ° C. | | | Conversion* | Efficiency | Drop, |
| No. | Inlet | Middle | Outlet | Mole Basis | (%) | mm Hg |
| C-1 | 934 | 1141 | 1006 | 0.949 | 79.7 | 41.1 |
| 1 | 948 | 1069 | 961 | 0.941 | 79.0 | 41.1 |
| 2 | 966 | 1068 | 968 | 0.935 | 76.0 | 41.1 |
| 3 | 941 | 956 | 936 | 0.988 | 88.9 | 72.9 |
| C-2 | 954 | 941 | 906 | 0.975 | 86.8 | 74.8 |

*Carbon conversion is the ratio of (CO + CO₂)/(CO + CO₂ + CH₄ + 2C₂′s) in the product gas.
**Cold gas efficiency is the heating value of the hydrogen and carbon monoxide generated divided by the heat input from the fuel (on a gross heating value basis).

TABLE 3
Autothermal Reactor Outlet Gas Composition, Mole %
(except H₂S) (Dry Basis)

| Ex | | | | | | | |
|---|---|---|---|---|---|---|---|
| No. | H₂ | N₂ | CO | CH₄ | CO₂ | C₂′s | H₂S (ppmv) |
| C-1 | 42.1 | 38.5 | 10.2 | 0.746 | 14.9 | 0.294 | 700 |
| 1 | 41.0 | 38.3 | 10.5 | 0.863 | 14.0 | 0.342 | 661 |
| 2 | 39.8 | 39.2 | 10.9 | 0.939 | 13.6 | 0.376 | 1055 |
| 3 | 43.0 | 37.9 | 10.9 | 0.305 | 14.1 | 0.004 | 993 |
| C-2 | 42.2 | 38.0 | 10.8 | 0.617 | 14.1 | 0.011 | 1066 |

These results indicate that when using the emulsion at the higher throughput condition (Example 3), higher cold gas efficiency, higher purity hydrogen and lower methane slip are provided as compared to the corresponding pure diesel fuel (Example C-2).

While the invention has been explained in relation to specific embodiments, it is to be understood that various modifications thereof will become apparent to those skilled in the art upon reading the specification. Therefore, it is to be understood that the invention disclosed herein is intended to cover such modifications as fall within the scope of the appended claims.

1. A process for making hydrogen gas, comprising:
(A) forming a water blended hydrocarbon feedstock composition comprising:
(i) a hydrocarbon feedstock;
(ii) water; and
(iii) at least one surfactant comprising:
(iii)(a) at least one product made from the reaction of an acylating agent with ammonia, an amine, an alcohol, or a mixture of two or more thereof;
(iii)(b) at least one product comprised of (I) a polycarboxylic acylating agent, and (II) a copolymer derived from at least one olefin monomer and at least one alpha, beta unsaturated carboxylic acid or derivative thereof linking group derived from a compound having two or more primary amino groups, two or more secondary amino groups, at least one primary amino group and at least one secondary amino group, at least two hydroxyl groups, or at least one primary or secondary amino group and at least one hydroxyl group;
(iii)(c) at least one aromatic Mannich derived from a hydroxy aromatic compound, an aldehyde or a ketone, and an amine containing at least one primary or secondary amino group;
(iii)(d) at least one ionic or a nonionic compound having a hydrophilic-lipophilic balance of about 1 to about 40; or
(iii)(e) mixture of two or more of (iii)(a) through (iii)(d); and
(B) steam reforming the water blended hydrocarbon feedstock composition formed in step (A) to convert the composition to a product comprising hydrogen and one or more carbon oxides.

2. The process of claim 1 wherein the water blended hydrocarbon feedstock composition formed in step (A) further comprises (iv) at least one water-soluble salt.

3. The process of claim 1 wherein prior to step (B) the water blended hydrocarbon feedstock composition formed in step (A) is partially oxidized to increase the temperature of the water blended hydrocarbon feedstock composition to a level sufficient for steam reforming.

4. The process of claim 1 wherein during step (B) steam is mixed with the composition formed in step (A) to form a vaporized mixture, the temperature of the vaporized mixture being in the range of about 50° C. to about 1200° C.

5. The process of claim 1 wherein the water blended hydrocarbon feedstock composition formed in step (A) is a water-in-oil emulsion, an oil-in-water emulsion or a micro-emulsion.

6. The process of claim 1 wherein the hydrocarbon feedstock comprises a natural oil, synthetic oil, or mixture thereof.

7. The process of claim 1 wherein the hydrocarbon feedstock comprises a distillate fuel.

8. The process of claim 1 wherein the hydrocarbon feedstock comprises naphtha, diesel fuel, fuel oil, kerosene or gasoline.

9. The process of claim 1 wherein the hydrocarbon feedstock comprises a hydrocarbon derived from a vegetable source, a mineral source, or mixture thereof.

10. The process of claim 1 wherein the hydrocarbon feedstock comprises a hydrocarbon derived from corn, alfalfa, soybean, rapseed, palm, shale, coal, tar sands, bitumen, residual oil, heavy oil, coke, or a mixture of two or more thereof.

11. The process of claim 1 wherein the hydrocarbon feedstock comprises a gaseous hydrocarbon dispersed in a liquid hydrocarbon.

12. The process of claim 11 wherein the gaseous hydrocarbon comprises a hydrocarbon of 1 to about 5 carbon atoms.

13. The process of claim 1 wherein the surfactant (iii)(a) is the product made by the reaction of a hydrocarbon-substituted carboxylic acid or reactive equivalent thereof with ammonia, an amine, an alcohol, or a mixture of two or more thereof, the hydrocarbon substituent of the acid or reactive equivalent containing about 6 to about 500 carbon atoms.

14. The process of claim 13 wherein the hydrocarbon-substituted carboxylic acid or reactive equivalent of surfactant (iii)(a) is a monocarboxylic acid.

15. The process of claim 13 wherein the hydrocarbon-substituted carboxylic acid or reactive equivalent of surfactant (iii)(a) is a polycarboxylic acid or anhydride.

16. The process of claim 13 wherein the hydrocarbon-substituted carboxylic acid or reactive equivalent is a hydrocarbon-substituted succinic acid or anhydride.

17. The process of claim 1 wherein the amine used in making surfactant (iii)(a) is a monoamine, polyamine, hydroxyamine, or mixture of two or more thereof.

18. The process of claim 1 wherein surfactant (iii)(a) comprises a mixture of at least two compounds: one of the compounds being the reaction product of a hydrocarbon-substituted succinic acid or anhydride with ammonia, an amine, an alcohol, or a mixture of two or more thereof, the hydrocarbon substituent of the one compound having about 6 to about 500 carbon atoms; another of the compounds being different than the one compound and being the reaction product of a hydrocarbon-substituted succinic acid or anhydride with ammonia, an amine, an alcohol, or a mixture of two or more thereof, the hydrocarbon substituent of the another compound having about 50 to about 500 carbon atoms.

19. The process of claim 1 wherein surfactant (iii)(a) comprises a mixture of at least two compounds: one of the compounds being the reaction product of a hydrocarbon-substituted succinic acid or anhydride with an alkanol amine; another of the compounds being the reaction product of a hydrocarbon-substituted succinic acid or anhydride with at least one ethylene polyamine.

20. The process of claim 1 wherein surfactant (iii)(a) comprises (I) a first polycarboxylic acylating agent having at least one hydrocarbon substituent of about 6 to about 500 carbon atoms, (II) a second polycarboxylic acylating agent optionally having at least one hydrocarbon substituent of up to about 500 carbon atoms, the polycarboxylic acylating agents (I) and (II) being the same or different and being linked together by (III) a linking group derived from a compound having two or more primary amino groups, two or more secondary amino groups, at least one primary amino group and at least one secondary amino group, at least two hydroxyl groups, or at least one primary or secondary amino group and at least one hydroxyl group, the polycarboxylic acylating agents (I) and (II) being reacted with ammonia, an amine, an alcohol, or a mixture of two or more thereof.

21. The process of claim 1 wherein surfactant (iii)(a) comprises a mixture of: the product made from the reaction of a polyisobutene-substituted succinic acid or anhydride with an alkanol amine wherein the polyisobutene group has about 8 to about 500 carbon atoms; the product made from the reaction of a hydrocarbon-substituted succinic acid or anhydride with an alkanol amine wherein the hydrocarbon substituent has about 6 to about 30 carbon atoms; and the product made from the reaction of a polyisobutene-substituted succinic acid or anhydride with at least one alkylene polyamine wherein in the polyisobutene group has about 8 to about 500 carbon atoms.

22. The process of claim 1 wherein the polycarboxylic acylating agent in surfactant (iii)(b) is a hydrocarbon-substituted carboxylic acid or reactive equivalent thereof, the hydrocarbon substituent of the acid or reactive equivalent containing about 6 to about 500 carbon atoms.

23. The process of claim 1 wherein the copolymer used in making the surfactant (iii)(b) is derived from an olefin monomer of 2 to about 30 carbon atoms.

24. The process of claim 1 wherein the alpha, beta-unsaturated carboxylic acid or derivative used in making the surfactant (iii)(b) is a monobasic or polybasic acid.

25. The process of claim 1 wherein the alpha, beta-unsaturated carboxylic acid or derivative used in making the surfactant (iii)(b) is an anhydride, ester, amide, imide, salt, acyl halide, nitrile, or mixture of two or more thereof.

26. The process of claim 1 wherein the linking group in the surfactant (iii)(b) is derived from a polyol, a polyamine, a hydroxyamine, or a mixture of two or more thereof.

27. The process of claim 1 wherein the surfactant (iii)(b) is comprised of a polyisobutene-substituted succinic anhydride and a copolymer derived from an alpha-olefin and maleic anhydride, the anhydride and the copolymer being linked together by an ethylene polyamine.

28. The process of claim 1 wherein the surfactant (iii)(c) is an aromatic Mannich compound derived from:
(iii)(c)(i) a hydroxy aromatic compound having the formula 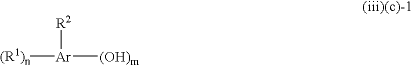
wherein in Formula (iii)(c)-1: Ar is an aromatic group; m is 1, 2 or 3; n is a number from 1 to about 4; with the proviso that the sum of m and n does not exceed the number of available positions on Ar that can be substituted; each R¹ independently is a hydrocarbon group of up to about 400 carbon atoms; and R² is H, amino or carboxyl;
(iii)(c)(ii) an aldehyde or ketone having the formula 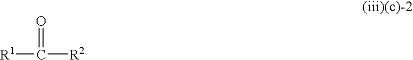
or a precursor thereof; wherein in Formula (iii)(c)-2: R¹ and R² independently are H or hydrocarbon groups having from 1 to about 1 8 carbon atoms; and R² can also be a carbonyl-containing hydrocarbon group having from 1 to about 18 carbon atoms; and
(iii)(c)(iii) an amine containing at least one primary or secondary amino group.

29. The process of claim 1 wherein the surfactant (iii)(c) is an aromatic Mannich compound derived from a polyisobutene-substituted phenol, paraformaldehyde, and an amine having at least one primary or secondary amino group.

30. The process of claim 1 wherein the surfactant (iii)(d) has a hydrophilic-lipophilic balance of about 1 to about 30.

31. The process of claim 1 wherein the surfactant (iii)(d) has a hydrophilic-lipophilic balance of about 7 to about 30.

32. The process of claim 1 wherein the surfactant (iii)(d) comprises an alkylaryl sulfonate, amine oxide, carboxylated alcohol ethoxylate, ethoxylated alcohol, ethoxylated alkyl phenol, ethoxylated amine, ethoxylated amide, ethoxylated fatty acid, ethoxylated fatty esters, ethoxylated fatty oil, fatty ester, glycerol ester, glycol ester, sorbitan ester, imidazoline derivative, lecithin, lecithin derivative, lignin, lignin derivative, monoglyceride, monoglyceride derivative, olefin sulfonate, phosphate ester, phosphate ester derivative, propoxylated fatty acid, ethoxylated fatty acid, propoxylated alcohol or alkyl phenol, ethoxylated alcohol or alkyl phenol, sorbitan derivative, sucrose ester, sulfonate of dodecyl or tridecyl benzene, naphthalene sulfonate, petroleum sulfonate, tridecyl or dodecyl benzene sulfonic acid, sulfosuccinate, sulfosuccinate derivative, or mixture of two or more thereof.

33. The process of claim 1 wherein the surfactant (iii)(d) comprises a copolymer represented by the formula 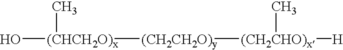
wherein x and x′ are independently numbers in the range of zero to about 20, and y is a number in the range of about 4 to about 60.

34. The process of claim 1 wherein the surfactant (iii)(d) is an ethoxylated alkyl phenol or an alkoxy polyethoxy alcohol.

35. The process of claim 1 wherein the surfactant (iii)(d) is an alkyl alcohol, amine, amide or acid ester.

36. The process of claim 2 wherein the water-soluble salt (iv) comprises an organic amine nitrate, azide or nitro compound; an alkali or alkaline earth metal carbonate, sulfate, sulfide, sulfonate or nitrate; or a mixture of two or more thereof.

37. The process of claim 2 wherein the water-soluble salt (iv) comprises an amine or ammonium salt represented by the formula
k[G(NR₃)_{y}]^{y+}nX^{p-}
wherein: G is hydrogen or an organic group of 1 to about 8 carbon atoms having a valence of y; each R independently is hydrogen or a hydrocarbon group of 1 to about 10 carbon atoms; X^{p-} is an anion having a valence of p; and k, y, n and p are independently integers of at least 1.

38. The process of claim 2 wherein the water-soluble salt (iv) comprises ammonium nitrate.

39. The process of claim 3 wherein the water blended hydrocarbon feedstock formed during step (A) further comprises an oxidation enhancing amount of (iv) at least one water-soluble salt, the water-soluble salt being an amine or ammonium nitrate.

40. The process of claim 1 wherein during step (A) components (i), (ii) and (iii) are mixed to form an emulsion, the emulsion including a dispersed phase, the dispersed phase being comprised of droplets having a mean diameter of about 0.05 to about 50 microns.

41. The process of claim 1 wherein during step (B) the water blended hydrocarbon feedstock composition formed in step (A) is steam reformed in the presence of steam reforming catalyst.

42. The process of claim 41 wherein the steam reforming catalyst is comprised of nickel, cobalt, platinum, palladium, rhodium, iridium, osmium, ruthenium, or a mixture of two or more thereof.

43. The process of claim 3 wherein the water blended hydrocarbon feedstock composition formed in step (A) is partially oxidized in the presence of an oxidation catalyst.

44. The process of claim 43 wherein the oxidation catalyst is comprised of platinum, palladium, rhodium, iridium, osmium, ruthenium, or a mixture of two or more thereof.

45. The process of claim 1 wherein during step (A) the water blended hydrocarbon feedstock contains from about 0.1 to about 99.9% by weight hydrocarbon feedstock, and about 99.9 to about 0.1% by weight water.

46. The process of claim 1 wherein during step (B) the water to carbon mole ratio is from about 1:2 to about 20:1, and the oxygen to carbon mole ratio is from about 0:1 to about 1:1.

47. A process of making hydrogen gas, comprising:
(A) forming an emulsion comprising:
(i) a hydrocarbon feedstock;
(ii) water;
(iii) a minor emulsifying amount of at least one surfactant comprising: at least one product made from the reaction of an acylating agent with ammonia or amine; at least one ionic or nonionic compound having a hydrophilic-lipophilic balance of about 1 to about 40; or a mixture thereof; and
(iv) ammonium nitrate; and
(B) steam reforming the emulsion formed in step (A) to convert the emulsion to a product comprising hydrogen and one or more carbon oxides.

48. A process for treating a refinery stream or product comprising hydrocracking, hydrorefining, hydrotreating or hydrodesulfurizing the refinery stream or product using hydrogen made by the process of claim 1.

49. A process comprising synthesizing ammonia, hydrogenating an aromatic compound, hydroforming an olefinic hydrocarbon to convert olefinic hydrocarbon to a branched chain paraffins, making alcohol from synthesis gas, or hydrogenating a fat or an oil, using hydrogen made by the process of claim 1.

50. A process comprising operating a fuel cell using hydrogen made by the process of claim 1.
